(19) United States
(12) Patent Application Publication
(10) Pub. No.: US 2011/0160054 A1
(43) Pub. Date: Jun. 30, 2011

(54) Pesticidal Mixtures Comprising Cyanosulfoximine Compounds and Spinetoram

(75) Inventors: Delphine Breuningger, Bobenheim-Roxheim (DE); Henricus Maria Martinus Basetiaans, Usingen (DE); Wolfgang Von Deyn, Neustadt (DE); Ralph Paulini, Durkheim (DE); Jügen Langewald, Mannhein (DE); Egon Haden, Ludwigshafen (DE)

(73) Assignee: BASF SE, LUDWIGSHAFEN (DE)

(21) Appl. No.: 13/060,782

(22) PCT Filed: Aug. 24, 2009
(86) PCT No.: PCT/EP09/60849

§ 371 Date: Feb. 25, 2011

Related U.S. Application Data
(60) Provisional application No. 61/092,552, filed on Aug. 28, 2008.

(51) Int. Cl. A01C 1/06; A01N 43/04; A01P 15/00; A01P 3/00

(52) U.S. Cl. 504/100; 514/28

(57) ABSTRACT

Pesticidal mixtures comprising Spinetoram and cyanosulfoximine compounds

The invention relates to pesticidal mixtures comprising as active compounds

1) at least one cyanosulfoximine compound I of the formula I

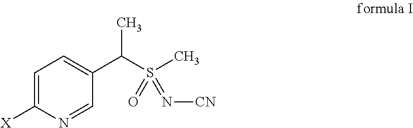

wherein X is Cl or CF₃;

and spinetoram

in synergistically effective amounts

and optionally

3) one active compound II selected from a group A comprising acteylcholine esterase inhibitors, GABA-gated chloride channel antagonists, sodium channel modulators, nicotinic acetylcholine receptor agonists/antagonists, chloride channel activators, juvenile hormone mimics, compounds affecting the oxidative phosphorylation, inhibitors of the chitin biosynthesis, moulting disruptors, inhibitors of the MET, voltage-dependent sodium channel blockers, inhibitors of the lipid synthesis and other compounds as defined in the description

4) one active fungicidal compounds III selected from azoles, strobilurins, carboxamides, carbamates, heterocyclic and various other compounds as defined in the description.

The invention relates further to methods and use of these pesticidal mixtures for combating insects, arachnids or nematodes and harmful fungis in and on plants, and for protecting such plants being infested with pests and also for protecting seeds.

The invention relates to new pesticidal mixtures of active ingredients having synergistically enhanced action. The said active ingredients comprise cyanosulfoximine compounds, spinetoram and optionally other pesticidal effective compounds. The invention relates further also to methods and use of these mixtures for combating insects, arachnids or nematodes in and on plants and animals, and for protecting such plants and animals being infested with pests and also for protecting seeds.

One typical object arising in the field of pest control lies in the need to reduce the dosage rates of the active ingredient in order to reduce or avoid unfavorable environmental or toxicological effects whilst still allowing effective pest control.

Another object encountered concerns the need to have available pest control agents which are effective against a broad spectrum of pests.

There also exists the need for pest control agents that combine know-down activity with prolonged control, that is, fast action with long lasting action.

Another difficulty in relation to the use of pesticides is that the repeated and exclusive application of an individual pesticidal compound leads in many cases to a rapid selection of pests which have developed natural or adapted resistance against the active compound in question. Therefore there is a need for pest control agents that help prevent or overcome resistance.

It was therefore an object of the present invention to provide pesticidal mixtures which solve at least one of the discussed problems such as reducing the dosage rate, enhancing the spectrum of activity or combining know-down activity with prolonged control or as to resistance management.

The combating of harmful phytopathogenic fungi is in many regions not the only problem the farmer has to face. Harmful insects can as well and often simultaneously cause great damages to crops and other plants. An efficient combination of fungicidal and insecticidal activity was desired to achieve with the present invention. Thus, it was a further object of the present invention to provide a mixture which, on the one hand, has good fungicidal activity, and, on the other hand, good insecticidal activity, resulting in a broader pesticidal spectrum of action. Besides providing pesticidal mixtures with an appealing toxicological profile, it was another object to achieve pesticidal mixtures which are quite environemtally friendly.

We have found that this object is in part or in whole achieved by the combination of active compounds defined as in the following. Moreover, we have found that simultaneous, that is joint or separate, application of the different active compounds or successive application thereof enhanced control of pests compared to the control rates that are possible with the individual compounds.

The present invention relates therefore to pesticidal mixtures comprising as active compounds
1) at least one active cyanosulfoximine compound I of formula I:

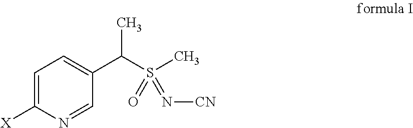

wherein
X is Cl or CF₃
or an enantiomer or a diastereomer thereof, pure or as mixtures of these enantiomers and/or diastereomers
and/or salts
and
2) spinetoram
in synergistically effective amounts.

The present invention further relates to mixtures comprising, additionally to the cyanosulfoximine compound I and spinetoram at least one other pesticide such as one or more insecticides and/or one or more fungicides as active ingredient. Possible additional pesticides to the mixture as defined in the present invention can be compounds of formula II or III defined hereafter.

The active compound II is selected from group II.A consisting of

II.A.1 Acetylcholine esterase inhibitors selected from triazemate or from the class of carbamates consisting of aldicarb, alanycarb, benfuracarb, carbaryl, carbofuran, carbosulfan, methiocarb, methomyl, oxamyl, primicarb, propoxur and thiodicarb, or from the class of organophosphates consisting of acephate, azinphos-ethyl, azinphos-methyl, chlorfenvinphos, chlorpyrifos, chlorpyrifos-methyl, demeton-S-methyl, diazinon, dichlorvos/DDVP, dicrotophos, dimethoate, disulfoton, ethion, fenitrothion, fenthion, isoxathion, malathion, methamidaphos, methidathion, mevinphos, monocrotophos, oxymethoate, oxydemeton-methyl, parathion, parathion-methyl, phenthoate, phorate, phosalone, phosmet, phosphamidon, pirimiphos-methyl, quinalphos, terbufos, tetrachlorvinphos, triazophos and trichlorfon;

II.A.2 GABA-gated chloride channel antagonists selected from the cyclodiene organochlorine endosulfan, N-Ethyl-2,2-dimethylpropionamide-2-(2,6-dichloro-α.α.α-trifluoro-p-tolyl) hydrazon, N-Ethyl-2,2-dichloro-1-methylcyclopropane-carboxamide-2-(2,6-dichloro-α.α.α-trifluoro-p-tolyl) hydrazon or from the class of phenylpyrazoles consisting of acetoprole, ethiprole, fipronil, pyrafluprole, pyriprole, vaniliprole and the phenylpyrazole compound II.A^{2.1}:

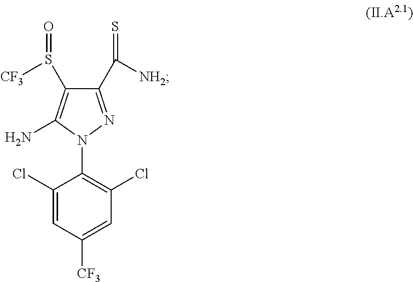

II.A.3 Sodium channel modulators selected from the class of pyrethroids consisting of allethrin, bifenthrin, cyfluthrin, lambda-cyhalothrin, cypermethrin, alpha-cypermethrin, beta-cypermethrin, zeta-cypermethrin, deltamethrin, esfenvalerate, etofenprox, fenpropathrin, fenvalerate, flucythrinate, tau-fluvalinate, permethrin, silafluofen and tralomethrin;

II.A.4 Nicotinic acetylcholine receptor agonists/antagonists selected from nicotin, cartap hydrochloride, thiocyclam or from the class of neonicotinoids consisting of acetamiprid, chlothianidin, dinotefuran, imidacloprid, nitenpyram, thiacloprid, thiamethoxam and AKD-1022; or the allosteric nicotinic acteylcholine receptor agonist spinosad;

II.A.5 Chloride channel activators selected from abamectin, emamectin benzoate, lepimectin or milbemectin;

II.A.6 Juvenile hormone mimics selected from hydroprene, kinoprene, fenoxycarb or pyriproxyfen;

II.A.7 Compounds affecting the oxidative phosphorylation selected from diafenthiuron, fenbutatin oxide, propargite or chlorfenapyr;

II.A.8 Inhibitors of the chitin biosynthesis selected from buprofezin or from the class of benzylureas consisting of bistrifluron, diflubenzuron, flufenoxuron, hexaflumuron, lufenuron, novaluron and teflubenzuron;

II.A.9 Moulting disruptors selected from cyromazine or from the class of ecdysone agonists consisting of methoxyfenozide, tebufenozide and azadirachtin;

II.A.10 Mitochondrial electron transport inhibitors selected from pyridaben, tolfenpyrad or flufenerim;

II.A.11 Voltage-dependent sodium channel blockers selected from indoxacarb or metaflumizone;

II.A.12 Inhibitors of the lipid synthesis selected from spirodiclofen, spiromesifen or spirotetramat.

II.A.13 group of various compounds consisting of amidoflumet, amitraz, bifenazate, clofentezine, cyenopyrafen, cyflumetofen, etoxazole, flonicamid, flubendiamine, flupyrazophos, hexythiazox, piperonyl butoxide, pymetrozine, pyridalyl, pyrifluquinazon, chlorantraniliprole, the anthranilamid compound II.A^{13.1}:

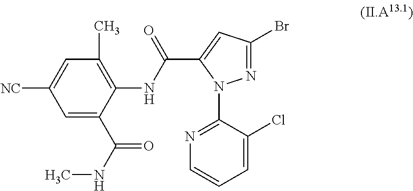

and the phenylsulfonamide compounds 2-Cyano-N-ethyl-4-fluoro-3-methoxy-benzenesulfonamide, 2-Cyano-N-ethyl-3-methoxy-benzenesulfonamide, 2-Cyano-3-difluoromethoxy-N-ethyl-4-fluoro-benzenesulfonamide, 2-Cyano-3-difluoromethoxy-N-ethyl-benzenesulfonamide, 2-Cyano-6-fluoro-3-methoxy-N,N-dimethyl-benzenesulfonamide, 2-Cyano-3-methoxy-N,N-dimethyl-benzenesulfonamide, 2-Cyano-N-ethyl-6-fluoro-3-methoxy-N-methyl-benzenesulfonamide and 2-Cyano-3-difluoromethoxy-N,N-dimethyl-benzenesulfonamide.

enantiomers or diastereomers thereof, pure or as mixtures of these enantiomers and/or diastereomers and/or salts.

The active compound III is a fungicidal compound selected from the groups III.A to III.F:

III.A azoles such as triazoles, imidazoles, pyrazoles, thiazoles and oxazoles selected from the group consisting of azaconazole, benomyl, bitertanol, bromuconazole, carbendazim, cyproconazole, cyazofamid, difenoconazole, diniconazole, diniconazole-M, enilconazole, epoxiconazole, ethaboxam, etridiazole, fluquinconazole, fenbuconazole, flusilazole, flutriafol, fuberidazole, hexaconazole, hymexazole, imazalil, imazalil-sulfphate, imibenconazole, ipconazole, metconazole, myclobutanil, oxpoconazol, paclobutrazol, pefurazoate, penconazole, prochloraz, propiconazole, prothioconazole, simeconazole, triadimefon, triadimenol, tebuconazole, tetraconazole, thiabendazole, triticonazole, triflumizole, uniconazol, 1-(4-chloro-phenyl)-2-([1,2,4]triazol-1-yl)-cycloheptanol;

III.B strobilurins selected from the group consisting of azoxystrobin, dimoxystrobin, enestroburin, fluoxastrobin, kresoxim-methyl, methominostrobin, orysastrobin, picoxystrobin, pyraclostrobin, pyribencarb, trifloxystrobin, methyl 2-(ortho-(2,5-dimethylphenyloxymethylene)phenyl)-3-methoxy-acrylate, 2-(2-(6-(3-chloro-2-methyl-phenoxy)-5-fluoro-pyrimidin-4-yloxy)-phenyl)-2-methoxyimino-N-methyl-acetamide and 3-methoxy-2-(2-(N-(4-methoxy-phenyl)-cyclo-propanecarboximidoylsulfanylmethyl)-phenyl)-acrylic acid methyl ester;

III.C carboxamides selected from the group consisting of benalaxyl, benalaxyl-M, benodanil, bixafen, boscalid, carboxin, carpropamid, dimethomorph, diclocymet, fenhexamid, fluopyram, flutolanil, furametpyr, flumorph, flumetoyer, fluopicolide (picobenzamid), mandipropamid, mepronil, metalaxyl, mefenoxam, ofurace, oxadixyl, oxycarboxin, oxytetracyclin, penthiopyrad, silthiofam,thifluzamide, tiadinil, zoxamide, 5-fluoro-1,3-dimethyl-1H-pyrazole-4-carboxylic acid [2-(1,2-dimethyl-propyl)-phenyl]-amide, methyl-3-(4-chlorophenyl)-3-(2-isopropoxycarbonylamino-3-methylbutyrylamino)propionate, 2-chloro-N-(1,1,3-trimethyl-indan-4-yl)-nicotinamide, N-(3-ethyl-3,5-5-trimethyl-cyclohexyl)-3-formylamino-2-hydroxy-benzamide, N-(2-{4-[3-(4-chlorophenyl)prop-2-ynyloxy]-3-methoxyphenyl}ethyl)-2-methanesulfonylamino-3-methylbutyramide, N-(2-{4-[3-(4-chlorophenyl)-prop-2-ynyloxy]-3-methoxyphenyl}ethyl)-2-ethanesulfonylamino-3-methyl-butyramide, N-(6-methoxy-pyridin-3-yl)cyclopropane-carboxamide, 2-amino-4-methyl-thiazole-5-carboxamide, N-(2-cyanophenyI)-3,4-dichloroisothiazole-5-carboxamide, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide, N-(3′,4′-dichloro-5-fluorobiphenyl-2-yl)-3-difluoromethyl-1-methylpyrazole-4-carboxamide; N-(3′,4′-dichloro-4-fluorobiphenyl-2-yl)-3-difluoromethyl-1-methylpyrazole-4-carboxamide, N-(3′,4′-dichloro-5-fluorobiphenyl-2-yl)-3-difluoromethyl-1-methylpyrazole-4-carboxamide, N-(2-(1,3-dimethylbutyl)-phenyl)-1,3-dimethyl-5-fluoro-1H-pyrazole-4-carboxamide, N-(4′-chloro-3′,5-difluoro-biphenyl-2-yl)-3-difluoromethyl-1-methyl-1H-pyrazole-4-carbox amide, N-(4′-chloro-3′,5-difluoro-biphenyl-2-yl)-3-trifluoromethyl-1-methyl-1H-pyrazole-4-carboxamide, N-(3′,4′-dichloro-5-fluoro-biphenyl-2-yl)-3-trifluoromethyl-1-methyl-1H-pyrazole-4-carbox amide, N-(3′,5-difluoro-4′-methyl-biphenyl-2-yl)-3-difluoromethyl-1-methyl-1H-pyrazole-4-carboxamide,N-(3′,5-difluoro-4′-methyl-biphenyl-2-yl)-3-trifluoromethyl-1-methyl-1H-pyrazole-4-carboxamide, N-(cis-2-bicyclopropyl-2-yl-phenyl)-3-difluoromethyl-1-methyl-1H-pyrazole-4-carboxamide, N-(trans-2-bicyclopropyl-2-yl-phenyl)-3-difluoromethyl-1-methyl-1H-pyrazole-4-carboxamide, N-(2′,4′-difluorobiphenyl-2-yl)-1-methyl-3-trifluoromethyl-1H-pyrazole-4-carboxamide, N-(2′,4′-dichlorobiphenyl-2-yl)-1-methyl-3-trifluoromethyl-1H-pyrazole-4-carboxamide, N-(2′,4′-difluorobiphenyl-2-yl)-3-difluoromethyl-1-methyl-1H-pyrazole-4-carboxamide, N-(2′,4′-dichlorobiphenyl-2-yl)-3-difluoromethyl-1-methyl-1H-pyrazole-4-carboxamide, N-(2′,5′-difluorobiphenyl-2-yl)-1-methyl-3-trifluoromethyl-1H-pyrazole-4-carboxamide, N-(2′,5′-dichlorobiphenyl-2-yl)-1-methyl-3-trifluoromethyl-1H-pyrazole-4-carboxamide, N-(2′,5′-difluorobiphenyl-2-yl)-3-difluoromethyl-1-methyl-1H-pyrazole-4-carboxamide, N-(2′,5′-dichlorobiphenyl-2-yl)-3-difluoromethyl-1-methyl-1H-pyrazole-4-carboxamide, N-(3′,5′-difluorobiphenyl-2-yl)-1-methyl-3-trifluoromethyl-1H-pyrazole-4-carboxamide, N-(3′,5′-dichlorobiphenyl-2-yl)-1-methyl-3-trifluoromethyl-1H-pyrazole-4-carboxamide, N-(3′,5′-difluorobiphenyl-2-yl)-3-difluoromethyl-1-methyl-1H-pyrazole-4-carboxamide, N-(3′,5′-dichlorobiphenyl-2-yl)-3-difluoromethyl-1-methyl-1H-pyrazole-4-carboxamide, N-(3′-fluorobiphenyl-2-yl)-1-methyl-3-trifluoromethyl-1H-pyrazole-4-carboxamide, N-(3′-chlorobiphenyl-2-yl)-1-methyl-3-trifluoromethyl-1H-pyrazole-4-carboxamide; N-(3′-fluorobiphenyl-2-yl)-3-difluoromethyl-1-methyl-1H-pyrazole-4-carboxamide, N-(3′-chlorobiphenyl-2-yl)-3-difluoromethyl-1-methyl-1H-pyrazole-4-carboxamide, N-(2′-fluorobiphenyl-2-yl)-1-methyl-3-trifluoromethyl-1H-pyrazole-4-carboxamide, N-(2′-chlorobiphenyl-2-yl)-1-methyl-3-trifluoromethyl-1H-pyrazole-4-carboxamide, N-(2′-fluorobiphenyl-2-yl)-3-difluoromethyl-1-methyl-1H-pyrazole-4-carboxamide, N-(2′-chlorbiphenyl-2-yl)-3-difluoromethyl-1-methyl-1H-pyrazole-4-carboxamide; N-(2′-fluoro-4′-chloro-5′-methylbiphenyl-2-yl)-1-methyl-3-trifluoromethyl-1H-pyrazole-4-carboxamide, N-(3′,4′,5′-trifluorobiphenyl-2-yl)-1-methyl-3-trifluoromethyl-1H-pyrazole-4-carboxamide, N-(3′,4′,5′-trifluorobiphenyl-2-yl)-1-methyl-3-difluoromethyl-1H-pyrazole-4-carboxamide, N-(2′,4′,5′-trifluorobiphenyl-2-yl)-1-methyl-3-difluoromethyl-1H-pyrazole-4-carboxamide, N-(3′,4′,5′-trifluorobiphenyl-2-yl)-3-chlorofluoromethyl-1-methyl-1H-pyrazole-4-carboxamide, N-[2-(1,1,2,3,3,3-hexafluoropropoxy)phenyl]-1-methyl-3-trifluoromethyl-1H-pyrazole-4-carboxamide, N-[2-(1,1,2,3,3,3-hexafluoropropoxy)-phenyl]-3-difluoromethyl-1-methyl-1H-pyrazole-4-carboxamide, N-[2-(2-chloro-1,1,2-trifluoroethoxy)phenyl]-1-methyl-3-trifluoromethyl-1H-pyrazole-4-carboxamide, N-[2-(2-chlor-1,1,2-trifluoroethoxy)phenyl]-3-difluoromethyl-1-methyl-1H-pyrazole-4-carboxamide, N-[2-(1,1,2,2-tetrafluoroethoxy)phenyl]-3-difluoromethyl-1-methyl-1H-pyrazole-4-carboxamide, N-[2-(1,1,2,2-tetrafluoroethoxy)phenyl]-1-methyl-3-trifluoromethyl-1H-pyrazole-4-carboxamide, N-(4′-(trifluoromethylthio)biphenyl-2-yl)-3-difluoromethyl-1-methyl-1H-pyrazole-4-carboxamide, N-(4′-(trifluoromethylthio)biphenyl-2-yl)-1-methyl-3-trifluoromethyl-1H-pyrazole-4-carboxamide;

III.D heterocyclic compounds selected from the group consisting of acibenzolar-S-methyl, anilazine, aldimorph, blasticidin-S, bupirimate, captafol, captan, chinomethionat, cyprodinil, dazomet, debacarb, diclomezine, difenzoquat, difenzoquat-methylsulphat, diflumetorim, dodemorph, dodemorph-acetate, famoxadone, fenamidone, fenarimol, ferimzone, fenpiclonil, fenpropidin, fenpropimorph, fludioxonil, fluazinam, fluoroimid, folpet, fenoxanil, iprodione, mepanipyrim, nitrapyrin, nuarimol, octhilinone, oxolinic acid, piperalin, probenazole, procymidone, proquinazid, pyrifenox, pyrimethanil, pyroquilon, quinoxyfen, tricyclazole, triforine, tridemorph, vinclozolin, 5-chloro-7-(4-methylpiperidin-1-yl)-6-(2,4,6-trifluorophenyl)-[1,2,4]triazolo[1,5-a]pyrimidine, 6-(4-tert-butylphenyl)-5-methyl-[1,2,4]triazolo[1,5-a]pyrimidine-7-ylamine, 5-methyl-6-(3,5,5-trimethyl-hexyl)-[1,2,4]triazolo[1,5-a]pyrimidine-7-ylamine, 5-methyl-6-octyl-[1,2,4]triazolo[1,5-a]pyrimidine-7-yl-amine, 6-methyl-5-octyl-[1,2,4]tri-azolo[1,5-a]pyrimidine-7-yl-amine, 6-ethyl-5-octyl-[1,2,4]triazolo[1,5-a]pyrimidine-7-yl-amine, 5-ethyl-6-octyl-[1,2,4]triazolo[1,5-a]pyri-midine-7-ylamine, 5-ethyl-6-(3,5,5-trimethyl-hexyl)-[1,2,4]tri-azo-lo[1,5-a]pyrimi-dine-7-ylamine, 6-octyl-5-propyl-[1,2,4]triazolo[1,5-a]pyrimidine-7-yl-amine, 5-methoxy-methyl-6-octyl-[1,2,4]triazolo[1,5-a]pyrimidine-7-yl-amine, 6-octyl-5-trifluoromethyl-[1,2,4]triazolo[1,5-a]pyrimidine-7-yl-amine and 5-trifluoromethyl-6-(3,5,5-trimethyl-hexyl)-[1,2,4]tri-azolo[1,5-a]pyrimidine-7-ylamine, 2,3,5,6-tetrachloro-4-methanesulfonyl-pyridine, 3,4,5-trichloro-pyridine-2,6-di-carbonitrile, N-(1-(5-bromo-3-chloro-pyridin-2-yl)-ethyl)-2,4-dichloro-nicotinamide, N-((5-bromo-3-chloro-pyridin-2-yl)-methyl)-2,4-dichloro-nicotinamide, 2-butoxy-6-iodo-3-propylchromen-4-one and N,N-dimethyl-3-(3-bromo-6-fluoro-2-methylindole-1-sulfonyl)-[1,2,4]triazole-1-sulfonamide;

III.E carbamates selected from the group consisting of diethofencarb, ferbam, fluben-thiavalicarb, iprovalicarb, mancozeb, maneb, metam, methasulphocarb, metiram, propamocarb, propamocarb hydrochlorid,propineb, thiram, zineb, ziram, 4-fluorophenyl N-(1-(1-(4-cyanophenyl)ethanesulfonyl)but-2-yl)carbamate, methyl 3-(4-chlorophenyl)-3-(2-isopropoxycarbonylamino-3-methyl-butyrylamino)propanoate and carbamate oxime ethers of the formula III^{E.1}

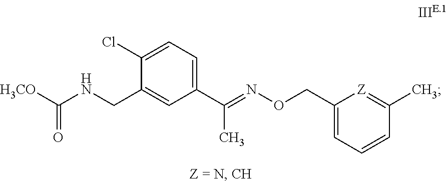

III.F fungicides selected from

the group of antibiotics comprising kasugamycin, kasugamycin-hydrochlorid-hydrat, mildiomycin, streptomycin, polyoxin and validamycin A;

the group of nitrophenyl derivatives comprising binapacryl, dinocap, dinobuton, di-cloran, nitrothal-isopropyl and tecnazen;

the group of sulfur-containing heterocyclyl compounds comprising dithianon and iso-prothiolane;

the group of organometallic compounds comprising fentin salts;

the group of organophosphorus compounds comprising edifenphos, iprobenfos, fosetyl, fosetyl-aluminum, phosphorous acid and its salts, pyrazophos and tolclofos-methyl;

the group of organochlorine compounds comprising chlorothalonil, dichlofluanid, di-chlorophen, pentachlorophenol and its salts, flusulfamide, hexachlorobenzene, phthalide, pencycuron, quintozene, thiophanate-methyl and tolylfluanid;

the group of inorganic active compounds comprising Bordeaux mixture, copper acetate, copper hydroxide, copper oxychloride, basic copper sulfate, oxin-copper and sulfur;

and/or selected from a group of various fungicides consisting of biphenyl, bronopol, cyflufenamid, cymoxanil, diphenylamine, dimethirimol, dodine, dodine free base, ethirimol, furalaxyl, iminoctadine, iminoctadine-triacetate, iminoctadine-tris(albesilate), guazatine, guazatine-acetate, metrafenone, prohexadione calcium, spiroxamine guanidine, N-(4-chloro-2-nitro-phenyl)-N-ethyl-4-methyl-benzenesulfon-amide, N-(cyclopropylmethoxyimino-(6-difluoromethoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluormethyl-4-(3-trimethylsilanyl-propoxy)-phenyl)-N-ethyl-N-methyl formamidine and N′-(5-difluormethyl-2-methyl-4-(3-trimethylsilanyl-propoxy)-phenyl)-N-ethyl-N-methyl formamidine;

enantiomers or diastereomers thereof, pure or as mixtures of these enantiomers and/or diastereomers and/or salts.

We have accordingly found that several objects can be achieved by the above pesticidal mixtures, defined in the present application. Pesticidal mixtures comprising at least one compound I and spinetoram show synergistic effects. The effectiveness of this combination of compounds may even be enhanced by a combination with one or more further pesticides. In particular the fungicidal and/or insecticidal effect may be increased in a superadditive manner by adding to the pesticidal mixture further fungicides and/or insecticides such as compounds II or III as additional active compounds.

The present invention also provides methods for the control of arthropodal pests such as insects, arachnids or nematodes comprising contacting the insect, arachnid or nematode or their food supply, habitat, breeding grounds or their locus with a pesticidally effective amount of pesticidal mixtures of the active compound I and spinetoram and optionally one active compound II or Ill.

Moreover, the present invention also relates to a method of protecting plants from attack or infestation by arthropodal pests such as insects, acarids or nematodes comprising contacting the plant, or the soil or water in which the plant is growing, with a pesticidally effective amount of a mixture of the active compound I with at least spinetoram and optionally one active compound II or III.

Moreover, we have found that simultaneous, that is joint or separate, application of at least one compound I and spinetoram and optionally one of the active compounds II or III or successive application thereof, e.g. of at least one compound I and spinetoram and at least one of the active compounds III allows better control of harmful fungi than is possible with the individual compounds alone (synergistic mixtures).

Moreover, the present invention relates to:
agricultural compositions comprising a mixture of at least one active compound I and spinetoram and optionally at least one active compound II or III;
the use of a mixture of at least one active compound I and spinetoram and optionally at least one active compound II or Ill for combating animal pests;
the use of a mixture of at least one active compound I and spinetoram and optionally at least one active compound II for combating phytopathogenic harmful fungi;
a method of combating animal pests which comprises contacting the animal pests, their habit, breeding ground, food supply, plant, seed, soil, area, material or environment in which the animal pests are growing or may grow, or the materials, plants, seeds, soils, surfaces or spaces to be protected from animal attack or infestation with a pesticidally effective amount of a mixture of at least one active compound I and spinetoram and optionally at least one active compound II or a method for protecting crops from attack or infestation by animal pests and/or phythopathogenic harmful fungi, which comprises contacting a crop with a mixture of at least one active compound I and spinetoram and optionally at least one active compound II or III;
a method for the protection of seeds from soil insects and of the seedlings' roots and shoots from soil and foliar insects and/or phythopathogenic harmful fungi comprising contacting the seeds before sowing and/or after pregermination with a mixture of at least one active compound I and spinetoram and optionally at least one active compound II or III;

and
seed comprising a mixture of at least one active compound I and spinetoram and optionally at least one active compound II or III.

The pesticidal mixture of compound(s) I and spinetoram can be used as synergists for a large number of different fungicidal and /or insecticidal active compounds. By simultaneous, that is joint or separate, application of the mixture of compound(s) I and spinetoram with at least one active compound II or III, the fungicidal and/or insecticidal activity is increased and may even be increased in a superadditive manner.

The invention also relates to the use of a pesticidal mixture according to the invention for combating insects, arachnids or nematodes.

The invention also relates to a method for protecting animals against infestation or infection by parasites which comprises administering to the animals a parasitically effective amount of a pesticidal mixture according to the invention to the animal in need thereof.

The invention also relates to a method for treating animals infestated or infected by parasites which comprises administering to the animals a parasitically effective amount of a pesticidal mixture according to the invention.

Compounds I

Compounds I of the formula I, their preparation and their action against insect and acarid pests have been described in WO 2006/060029, WO 2007/095229, US 2007/0299264 and US 2008/0108665. Preparation methods of active compounds I of formula I can be found therein.

Spinetoram

The active compound Spinetoram is already known from the literature. Spinetoram [CAS: 935545-74-7] is the common name of a commercially available mixture of 50-90% of 3′-O-Ethyl-5,6-dihydro-Spinosyn J [CAS: 187166-40-1] and from 10-50% of 3′-O-Ethyl-Spinosyn L [CAS: 187166-15-0].

According to the spinetoram data sheet, the stereochemistry at position 5a is still under discussion at the bridged fused ring systems nomenclature. The given nomenclature according to the data sheet is:

(2R,3aR,5aR,5bS,9S,13S,14R,16aS,16bR)-2-[(6-deoxy-3-O-ethyl-2,4-di-O-methyl-α-L-mannopyranosyl)oxy]-13-[[(2R,5S,6R)-5-(dimethylamino)tetrahydro-6-methyl-2H-pyran-2-yl]oxy]-9-ethyl-2,3,3a,4,5,5a,5b,6,9,10,11,12,13,14,16a,16b-hexadecahydro-14-methyl-1H-as-indecano[3,2-o]oxacyclododecin-7,15-dione

mixture with

(2S,3aR,5aS,5bS,9S,13S,14R,16aS,16bS)-2-[(6-deoxy-3-O-ethyl-2,4-di-O-methyl-α-L-mannopyranosyl)oxy]-13-[[(2R,5S,6R)-5-(dimethylamino)tetrahydro-6-methyl-2H-pyran-2-yl]oxy]-9-ethyl-2,3,3a,5a,5b,6,9,10,11,12,13,14,16a,16b-tetradecahydro-4,14-dimethyl-1H-as-indaceno[3,2-d]oxacyclododecin-7,15-dione.

Methods for obtaining spinetoram are already known from the art or the person skilled in the art can obtain spinetoram through common methods.

For example, a process for producing spinetoram (also known as DE-175) and its use against insects have been described in WO 2007/139872, WO 2008/057520 and in U.S. Pat. No. 6,001,981. Additional information concerning spinetoram can be found in the report of the XVI International Plant protection Congress 2007.

Mixtures

A possible pesticidal mixture according to the invention comprises cyanosulfoximine compound I wherein X is Cl and spinetoram (Mα). Another possible mixture according to the invention comprises cyanosulfoximine compound I wherein X is CF₃ and spinetoram (Mβ).

The compounds of formula I include racemic mixtures, individual pure enantiomers and diasteroemers and optically active mixtures.

Spinetoram as meant in this invention may exis in several diastereomeric isomers. Because there are multiple stereogenic centers, it is anticipated that the diastreomeric isomers will have utility as insecticides.

Of course further specific mixtures Ma as well as further specific mixtures M6 are possible and are encompassed by the invention if combinations of specific enantiomers or diastereomers or salts of the cyanosulfoximine compound I with the possible diastereomers of spinetoram are considered. Although some diastereomeric isomers may be more efficacious than others, all the pesticidal mixtures comprising diastereomeric isomers of compound(s) of formula I and/or diastereoisomeric isomers of spinoteram are within the frame of the present invention.

Compounds II

The commercially available compounds II of the group II.A may be found in The Pesticide Manual, 13th Edition, British Crop Protection Council (2003) among other publications.

Thiamides derivatives in analogy of formula II.A^{2.1} and their preparation have been described in WO 98/28279. Lepimectin is known from Agro Project, PJB Publications Ltd, November 2004. Benclothiaz and its preparation have been described in EP-A1 454621. Methidathion and Paraoxon and their preparation have been described in Farm Chemicals Handbook, Volume 88, Meister Publishing Company, 2001. Acetoprole and its preparation have been described in WO 98/28277. Metaflumizone and its preparation have been described in EP-A1 462 456. Flupyrazofos has been described in Pesticide Science 54, 1988, p. 237-243 and in U.S. Pat. No. 4,822,779. Pyrafluprole and its preparation have been described in JP-A 2002-193709 and in WO 01/00614. Pyriprole and its preparation have been described in WO 98/45274 and in U.S. Pat. No. 6,335,357. Amidoflumet and its preparation have been described in U.S. Pat. No. 6,221,890 and in JP-A 21010907. Flufenerim and its preparation have been described in WO 03/007717 and in WO 03/007718. Cyflumetofen and its preparation have been described in WO 04/080180. Preparation methods for neonicotionids similar to AKD-1022 have been described by Zhang, A. et al. in J. Neurochemistry, 75(3), 2000, AKD 1022 and its preparation has been described in U.S. Pat. No. 6,300,348. Chloranthraniliprole has been described in WO 01/70671, WO 03/015519 and WO 05/118552. Anthranilamides derivatives in analogy of formula II.A^{13.1} and their preparation have been described in WO 01/70671; WO 02/48137; WO 03/24222, WO 03/15518, WO 04/67528; WO 04/33468 and WO 05/118552. The phenylsulfonamide compounds 2-Cyano-N-ethyl-4-fluoro-3-methoxy-benzenesulfonamide, 2-Cyano-N-ethyl-3-methoxy-benzenesulfonamide, 2-Cyano-3-difluoromethoxy-N-ethyl-4-fluoro-benzenesulfonamide, 2-Cyano-3-difluoromethoxy-N-ethyl-benzenesulfonamide, 2-Cyano-6-fluoro-3-methoxy-N,N-dimethyl-benzenesulfonamide, 2-Cyano-3-methoxy-N,N-dimethyl-benzenesulfonamide, 2-Cyano-N-ethyl-6-fluoro-3-methoxy-N-methyl-benzenesulfonamide and 2-Cyano-3-difluoromethoxy-N,N-dimethyl-benzenesulfonamide have been described in WO2005/035486, WO2006/056433 and in unpublished U.S. Ser. No. 60/843606.

Preferences

Preferred active compounds II selected from group II.A

With respect to their use in the pesticidal mixtures of the present invention, particular preference is given to the compounds II.A as listed in the paragraphs below.

With regard to the use in a pesticidal mixture of the present invention, the compound II selected from group II.A.1 as defined above is preferably triazemate or primicarb.

With regard to the use in a pesticidal mixture of the present invention, the compound II selected from group II.A.2 as defined above is preferably endosulfan, N-Ethyl-2,2-dimethylpropionamide-2-(2,6-dichloro-α.α.α-trifluoro-p-tolyl) hydrazon, N-Ethyl-2,2-dichloro-1-methylcyclopropane-carboxamide-2-(2,6-dichloro-α.α.α-trifluoro-p-tolyl) hydrazon, acetoprole, ethiprole, fipronil, pyrafluprole, pyriprole or vaniliprole or the phenylpyrazole compound II.A^{2.1}.

More preferably the compound II is N-Ethyl-2,2-dimethylpropionamide-2-(2,6-dichloro-α.α.α-trifluoro-p-tolyl) hydrazon, N-Ethyl-2,2-dichloro-1-methylcyclopropane-carboxamide-2-(2,6-dichloro-α.α.α-trifluoro-p-tolyl) hydrazon, acetoprole or fipronil.

With regard to the use in a pesticidal mixture of the present invention, the compound II selected from group II.A.3 as defined above is preferably allethrin, bifenthrin, cyfluthrin, lambda-cyhalothrin, cypermethrin, alpha-cypermethrin, beta-cypermethrin, zeta-cypermethrin, deltamethrin, etofenprox, fenpropathrin, fenvalerate, flucythrinate, tau-fluvalinate, silafluofen or tralomethrin.

More preferably the compound II is alpha-cypermethrin or deltamethrin.

With regard to the use in a pesticidal mixture of the present invention, the compound II selected from group II.A.4 as defined above is preferably thiocyclam or from the class of neonicotinoids acetamiprid, chlothianidin, dinotefuran, imidacloprid, nitenpyram, thi-acloprid, thiamethoxam and AKD-1022; or the allosteric nicotinic acteylcholine receptor agonist spinosad.

More preferably the compound II is clothianidine, imidacloprid or thiamethoxam.

With regard to the use in a pesticidal mixture of the present invention, the compound II selected from group II.A.5 as defined above is preferably abamectin, emamectin benzoate, lepimectin or milbemectin.

More preferably the compound II is abamectin.

With regard to the use in a pesticidal mixture of the present invention, the compound II selected from group II.A.7 as defined above is preferably diafenthiuron.

With regard to the use in a pesticidal mixture of the present invention, the compound II selected from group II.A.8 as defined above is preferably buprofezin.

With regard to the use in a pesticidal mixture of the present invention, the compound II selected from group II.A.10 as defined above is preferably pyridaben or flufenerim.

With regard to the use in a pesticidal mixture of the present invention, the compound II selected from group II.A.11 as defined above is preferably indoxacarb or metaflumizone.

More preferably the compound II is metaflumizone.

With regard to the use in a pesticidal mixture of the present invention, the compound II selected from group II.A.12 as defined above is preferably spirodiclofen, spiromesifen or spirotetramat.

More preferably the compound II is spiromesifen or spirotetramat.

With regard to the use in a pesticidal mixture of the present invention, the compound II selected from group II.A.13 as defined above is preferably amitraz, flonicamid, flubendiamine, pymetrozine, pyridalyl, pyrifluquinazon, chlorantraniliprole, the anthranilamid compound II.A^{13:1}, 2-Cyano-N-ethyl-4-fluoro-3-methoxy-benzenesulfonamide, 2-Cyano-N-ethyl-3-methoxy-benzenesulfonamide, 2-Cyano-3-difluoromethoxy-N-ethyl-4-fluoro-benzenesulfonamide, 2-Cyano-3-difluoromethoxy-N-ethyl-benzenesulfonamide, 2-Cyano-6-fluoro-3-methoxy-N,N-dimethyl-benzenesulfonamide, 2-Cyano-3-methoxy-N,N-dimethyl-benzenesulfonamide, 2-Cyano-N-ethyl-6-fluoro-3-methoxy-N-methyl-benzenesulfonamide or 2-Cyano-3-difluoromethoxy-N,N-dimethyl-benzenesulfonamide.

More preferably the compound II is flonicamid, pymetrozine, pyrifluquinazon, chloran-traniliprole, the anthranilamid compound II.A^{13.1}, 2-Cyano-N-ethyl-4-fluoro-3-methoxy-benzenesulfonamide, 2-Cyano-N-ethyl-3-methoxy-benzenesulfonamide, 2-Cyano-3-difluoromethoxy-N-ethyl-4-fluoro-benzenesulfonamide, 2-Cyano-3-difluoromethoxy-N-ethyl-benzenesulfonamide, 2-Cyano-6-fluoro-3-methoxy-N,N-dimethyl-benzenesulfonamide, 2-Cyano-3-methoxy-N,N-dimethyl-benzenesulfonamide, 2-Cyano-N-ethyl-6-fluoro-3-methoxy-N-methyl-benzenesulfonamide or 2-Cyano-3-difluoromethoxy-N,N-dimethyl-benzenesulfonamide

Especially preferred are pesticidal mixtures containing N-Ethyl-2,2-dimethylpropionamide-2-(2,6-dichloro-α.α.α-trifluoro-p-tolyl) hydrazon as compound II.

Especially preferred are pesticidal mixtures containing N-Ethyl-2,2-dichloro-1-methylcyclopropane-carboxamide-2-(2,6-dichloro-α.α.α-trifluoro-p-tolyl) hydrazon as compound II.

Especially preferred are pesticidal mixtures containing pymetrozine or pyrifluquinazon as compound II.

Especially preferred are pesticidal mixtures containing chlorantraniliprole or the anthranil compound II.A^{13.1} as compound II.

Especially preferred are pesticidal mixtures containing acetoprole as compound II.

Especially preferred are pesticidal mixtures containing fipronil as compound II.

Especially preferred are pesticidal mixtures containing alpha-cypermethrin as compound II.

Especially preferred are pesticidal mixtures containing clothianidin as compound II.

Especially preferred are pesticidal mixtures containing imidacloprid as compound II.

Especially preferred are pesticidal mixtures containing thiamethoxam as compound II.

Especially preferred are pesticidal mixtures containing pymetrozine as compound II.

Especially preferred are pesticidal mixtures containing flonicamid as compound II.

Especially preferred are pesticidal mixtures containing spiromesifen as compound II.

Especially preferred are pesticidal mixtures containing spirotetramat as compound II.

Especially preferred are pesticidal mixtures containing pyrifluquinazon as compound II.

Especially preferred are pesticidal mixtures containing chlorantraniliprole as compound II.

Especially preferred are pesticidal mixtures containing the anthranilamid compound II.A^{13.1}

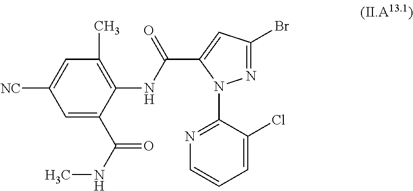

as compound II.

Especially preferred are pesticidal mixtures containing 2-Cyano-N-ethyl-4-fluoro-3-methoxy-benzenesulfonamide, 2-Cyano-N-ethyl-3-methoxy-benzenesulfonamide, 2-Cyano-3-difluoromethoxy-N-ethyl-4-fluoro-benzenesulfonamide, 2-Cyano-3-difluoromethoxy-N-ethyl-benzenesulfonamide, 2-Cyano-6-fluoro-3-methoxy-N,N-dimethyl-benzenesulfonamide, 2-Cyano-3-methoxy-N,N-dimethyl-benzenesulfonamide, 2-Cyano-N-ethyl-6-fluoro-3-methoxy-N-methyl-benzenesulfonamide or 2-Cyano-3-difluoromethoxy-N,N-dimethyl-benzenesulfonamide as compound II.

Especially preferred are pesticidal mixtures containing the phenylsulfonamide compound 2-Cyano-N-ethyl-4-fluoro-3-methoxy-benzenesulfonamide.

Especially preferred are pesticidal mixtures containing the phenylsulfonamide compound 2-Cyano-N-ethyl-3-methoxy-benzenesulfonamide.

Especially preferred are pesticidal mixtures containing the phenylsulfonamide compound 2-Cyano-3-difluoromethoxy-N-ethyl-4-fluoro-benzenesulfonamide.

Especially preferred are pesticidal mixtures containing the phenylsulfonamide compound 2-Cyano-3-difluoromethoxy-N-ethyl-benzenesulfonamide.

Especially preferred are pesticidal mixtures containing the phenylsulfonamide compound 2-Cyano-6-fluoro-3-methoxy-N,N-dimethyl-benzenesulfonamide.

Especially preferred are pesticidal mixtures containing the phenylsulfonamide compound 2-Cyano-3-methoxy-N,N-dimethyl-benzenesulfonamide.

Especially preferred are pesticidal mixtures containing the phenylsulfonamide compound 2-Cyano-N-ethyl-6-fluoro-3-methoxy-N-methyl-benzenesulfonamide.

Especially preferred are pesticidal mixtures containing the phenylsulfonamide compound 2-Cyano-3-difluoromethoxy-N,N-dimethyl-benzenesulfonamide.

Preferred pesticidal mixtures according to the invention

The following table M.I represents preferred combinations of the mixture Mα or Mβ with one active compound II of group II.A in mixtures according to the invention:

TABLE M.I

| Mixture Mα | Compound-II | Mixture Mβ | Compound II |
|---|---|---|---|
| Mα1 | Acetoprole | Mβ1 | Acetoprole |
| Mα2 | fipronil | Mβ2 | fipronil |
| Mα3 | anthranilamid II.A^{13.1} | Mβ3 | anthranilamid II.A^{13.1} |
| Mα4 | α-cypermethrin | Mβ4 | α-cypermethrin |
| Mα5 | deltamethrin | Mβ5 | deltamethrin |
| Mα6 | clothianidine | Mβ6 | clothianidine |
| Mα7 | imidacloprid | Mβ7 | imidacloprid |
| Mα8 | thiamethoxam | Mβ8 | thiamethoxam |
| Mα9 | abamectin | Mβ9 | abamectin |
| Mα10 | diafenthiuron | Mβ10 | diafenthiuron |
| Mα11 | buprofezin | Mβ11 | buprofezin |
| Mα12 | pyridaben | Mβ12 | pyridaben |
| Mα13 | flufenerim | Mβ13 | flufenerim |
| Mα14 | metaflumizone | Mβ14 | metaflumizone |
| Mα15 | spiromesifen | Mβ15 | spiromesifen |
| Mα16 | spirotetramat | Mβ16 | spirotetramat |
| Mα17 | flonicamid | Mβ17 | flonicamid |
| Mα18 | pymetrozine | Mβ18 | pymetrozine |
| Mα19 | pyrifluquinazone | Mβ19 | pyrifluquinazone |
| Mα20 | chlorantraniliprole | Mβ20 | chlorantraniliprole |
| Mα21 | anthranil | Mβ21 | anthranil |
| Mα22 | 2-Cyano-N-ethyl-4- | Mβ22 | 2-Cyano-N-ethyl-4- |
| | fluoro-3-methoxy- | | fluoro-3-methoxy- |
| | benzenesulfonamide | | benzenesulfonamide |
| Mα23 | 2-Cyano-N-ethyl- | Mβ23 | 2-Cyano-N-ethyl- |
| | 3-methoxy- | | 3-methoxy- |
| | benzenesulfonamide | | benzenesulfonamide |
| Mα24 | 2-Cyano-3- | Mβ24 | 2-Cyano-3- |
| | difluoromethoxy- | | difluoromethoxy- |
| | N-ethyl-4-fluoro- | | N-ethyl-4-fluoro- |
| | benzenesulfonamide | | benzenesulfonamide |
| Mα25 | 2-Cyano-3- | Mβ25 | 2-Cyano-3- |
| | difluoromethoxy- | | difluoromethoxy- |
| | N-ethyl- | | N-ethyl- |
| | benzenesulfonamide | | benzenesulfonamide |

Especially preferred are also inventive mixtures wherein the compound II of group II.A is N-Ethyl-2,2-dimethylpropionamide-2-(2,6-dichloro-α.α.α-trifluoro-p-tolyl) hydrazon.

Especially preferred are also inventive mixtures wherein the compound II of group II.A is N-Ethyl-2,2-dichloro-1-methylcyclopropane-carboxamide-2-(2,6-dichloro-α.α.α-trifluoro-p-tolyl) hydrazon.

Preferences of fungicidal compound III

Preference is furthermore also given to pesticidal mixtures according to the invention with compound selected from the compound III as listed in the paragraphs below. Particular preference is given to compounds of group III.F.

Preference is given to pesticidal mixtures according to the invention with compound III selected from the group III.A of azoles consisting of cyproconazole, difenoconazole, epoxiconazole, fluquinconazole, flusilazole, flutriafol, metconazole, myclobutanil, penconazole, propiconazole, prothioconazole, triadimefon, triadimenol, tebuconazole, tetraconazole, triticonazole, prochloraz, cyazofamid, benomyl, carbendazim and ethaboxam.

Preference is given to pesticidal mixtures according to the invention with compound III selected from the group III.A of azoles consisting of cyproconazole, difenoconazole, epoxiconazole, fluquinconazole, flusilazole, flutriafol, metconazole, myclobutanil, propiconazole, prothioconazole, triadimefon, triadimenol, tebuconazole, tetraconazole, triticonazole, prochloraz, cyazofamid, benomyl and carbendazim.

Very particular preference is given to pesticidal mixtures according to the invention with compound III selected from the group III.A of azoles consisting of benomyl, carbendazim, epoxiconazole, fluquinconazole, flutriafol, flusilazole, metconazole, prochloraz, prothioconazole, tebuconazole and triticonazole.

Preference is given to pesticidal mixtures according to the invention with compound III selected from the group III.B of strobilurins consisting of azoxystrobin, dimoxystrobin, fluoxastrobin, kresoxim-methyl, orysastrobin, picoxystrobin, pyraclostrobin and trifloxystrobin.

Particular preference is given to pesticidal mixtures according to the invention with compound III selected from the group p III.B of strobilurins consisting of azoxystrobin, kresoxim-methyl, orysastrobin and pyraclostrobin.

Very particular preference is given to pesticidal mixtures according to the invention with pyraclostrobin.

Preference is given to pesticidal mixtures according to the invention with compound III selected from the group III.C of carboxamides consisting of bixafen, boscalid, carpropamid, dimethomorph, fenhexamid, flumorph, fluopicolide (picobenzamid), fluopyram, isothianil, mandipropamid, metalaxyl, mefenoxam, ofurace, penthiopyrad and zoxamide.

Particular preference is given to pesticidal mixtures according to the invention with compound III selected from the group III.C of carboxamides consisting of boscalid, carpropamid, dimethomorph, fenhexamid, fluopicolide, fluopyram, mandipropamid, metalaxyl, mefenoxam, ofurace, penthiopyrad and zoxamide.

Very particular preference is given to pesticidal mixtures according to the invention with compound III selected from the group III.C of carboxamides consisting of boscalid, dimethomorph and penthiopyrad.

Preference is given to pesticidal mixtures according to the invention with compound III selected from the group III.D of heterocyclic compounds consisting of acibenzolar-S-methyl, captafol, cyprodinil, dodemorph, famoxadone fenamidone, fenarimol, fenpropimorph, fenpropidin, fenoxanil, fludioxonil, fluazinam, folpet, iprodione, mepanipyrim, probenazole, proquinazid, pyrimethanil, quinoxyfen triforine, tridemorph, vinclozolin and 5-chloro-7-(4-methylpiperidin-1-yl)-6-(2,4,6-trifluorophenyl)-[1,2,4]triazolo[1,5-a]pyrimidine.

Particular preference is given to pesticidal mixtures according to the invention with compound III selected from the group III.D of heterocyclic compounds consisting of dodemorph, famoxadone, fenpropimorph, iprodione, proquinazid, pyrimethanil, quinoxyfen, tridemorph, vinclozolin and 5-chloro-7-(4-methylpiperidin-1-yl)-6-(2,4,6-trifluorophenyl)-[1,2,4]triazolo[1,5-a]pyrimidine.

Very particular preference is given to pesticidal mixtures according to the invention with compound III selected from the group III.D of heterocyclic compounds consisting of dodemorph, famoxadone, fenpropimorph, proquinazid pyrimethanil, tridemorph and 5-chloro-7-(4-methylpiperidin-1-yl)-6-(2,4,6-trifluorophenyl)-[1,2,4]triazolo[1,5-a]pyrimidine.

Preference is also given to pesticidal mixtures according to the invention with compound III selected from the group III.E of carbamates consisting of iprovalicarb, flubenthiavalicarb, maneb, mancozeb, metiram, propineb, propamocarb and thiram.

Particular preference is also given to pesticidal mixtures according to the invention with compound III selected from the group III.E of carbamates consisting of iprovalicarb, flubenthiavalicarb, maneb, mancozeb, metiram and thiram.

Very particular preference is given to pesticidal mixtures according to the invention with compound III selected from the group III.E of carbamates consisting of maneb, mancozeb, metiram and thiram.

Preference is also given to pesticidal mixtures according to the invention with compound III selected from the group III.F of other fungicides consisting of chlorothalonil, copper acetate, copper hydroxide, copper oxychloride, basic copper sulfate, cymoxanil, dichlofluanid, dithianon, fentin salts, such as fentin acetate, fosetyl, fosetyl-aluminum, flusulfamide, metrafenone, phosphorous acid and its salts, thiophanate-methyl, sulfur and spiroxamine.

Particular preference is also given to pesticidal mixtures according to the invention with compound III selected from the group III.F of other fungicides consisting of chlorothalonil, dithianon, flusulfamide, fosetyl-aluminium, metrafenone, phosphorous acid and its salts and thiophanate-methyl.

Very particular preference is given to pesticidal mixtures according to the invention with compound III selected from the group III.F of other fungicides consisting of chlorothalonil, dithianon, flusulfamide, metrafenone and phosphorous acid and/or its salts.

Preferred combinations of mixture Mα or Mβ with fungicidal compound III

Mα as well as Mβ are generally most effective when applied against insects. High preference is given to the following combinations of the mixture Mα or Mβ according to the invention with fungicidal compounds III. The following table M.II represents preferred combinations according to the invention:

TABLE M.II

| Mixture | Compound III | Mixture | Compound III |
|---|---|---|---|
| Mα26 | benomyl | Mβ26 | benomyl |
| Mα27 | carbendazim | Mβ27 | carbendazim |
| Mα28 | epoxiconazole | Mβ28 | epoxiconazole |
| Mα29 | fluquinconazole | Mβ29 | fluquinconazole |
| Mα30 | flusilazole | Mβ30 | flusilazole |
| Mα31 | flutriafol | Mβ31 | flutriafol |
| Mα32 | metconazole | Mβ32 | metconazole |
| Mα33 | prochloraz | Mβ33 | prochloraz |
| Mα34 | prothioconazole | Mβ34 | prothioconazole |
| Mα35 | tebuconazole | Mβ35 | tebuconazole |
| Mα36 | triticonazole | Mβ36 | triticonazole |
| Mα37 | pyraclostrobin | Mβ37 | pyraclostrobin |
| Mα38 | boscalid | Mβ38 | boscalid |
| Mα39 | dimethomorph | Mβ39 | dimethomorph |
| Mα40 | penthiopyrad | Mβ40 | penthiopyrad |
| Mα41 | dodemorph | Mβ41 | dodemorph |
| Mα42 | famoxadone | Mβ42 | famoxadone |
| Mα43 | fenpropimorph | Mβ43 | fenpropimorph |
| Mα44 | proquinazid | Mβ44 | proquinazid |
| Mα45 | pyrimethanil | Mβ45 | pyrimethanil |
| Mα46 | tridemorph | Mβ46 | tridemorph |
| Mα47 | 5-chloro-7-(4-methyl- | Mβ47 | 5-chloro-7-(4-methyl- |
| | piperidin-1-yl)-6-(2,4,6- | | piperidin-1-yl)-6-(2,4,6- |
| | trifluorophenyl)- | | trifluorophenyl)- |
| | [1,2,4]triazolo[1,5- | | [1,2,4]triazolo[1,5- |
| | a]pyrimidine | | a]pyrimidine |
| Mα48 | maneb | Mβ48 | maneb |
| Mα49 | mancozeb | Mβ49 | mancozeb |
| Mα50 | metiram | Mβ50 | metiram |
| Mα51 | thiram | Mβ51 | thiram |
| Mα52 | chlorothalonil | Mβ52 | chlorothalonil |
| Mα53 | dithianon | Mβ53 | dithianon |
| Mα54 | flusulfamide | Mβ54 | flusulfamide |
| Mα55 | metrafenone | Mβ55 | metrafenone |
| Mα56 | Phosphorous acid | Mβ56 | Phosphorous acid |

Any of the above mixtures (Mα 1 to Mα 56 and Mβ 1 to Mβ 56) may be obtained by any of the methods described below.

Pests

The mixtures of the present invention have excellent activity against a broad spectrum of pest such as fungi and animal pests.

Animal Pests

The mixtures of the present invention have excellent activity against a broad spectrum of animal pests.

They are in particular suitable for efficiently controlling arthropodal pests such as arachnids, myriapedes and insects as well as nematodes. According to one embodiment they are suitable for efficiently controlling arachnids, insects and nematodes.

In particular, they are suitable for controlling insect pests, such as insects from the order of

lepidopterans (Lepidoptera), for example Agrotis ypsilon, Agrotis segetum, Alabama argfilacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocniatis citrella, Pieris brassicae, Plathypena scabra, Plutella xylostella, Pseudoplusia includens, Rhyacionia frustrana, Scrobipalpula absoluta, Sitotroga cerealella, Sparganothia pilleriana, Spodoptera frugiperda, Spodoptera littoralis, Spodoptera litura, Thaumatopoea pityocampa, Tortrix viridana, Trichoplusia ni and Zeiraphera canadensis;

beetles (Coleoptera), for example Agrilus sinuatus, Agriotes lineatus, Agriotes obscurus, Amphimallus solstitialis, Anisandrus dispar, Anthonomus grandis, Anthonomus pomorum, Aphthona euphoridae, Athous haemorrhoidalis, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcate, Cetonia aurata, Ceuthorrhynchus assimllis, Ceuthorrhynchus napi, Chaetocnema tibialis, Conoderus vespertinus, Criocena asparagi, Ctenicera ssp., Diabrotica longicornis, Diabrotica semipunctata, Diabrotica 12-punctata Diabrotica speciosa, Diabrotica virgifera, Epfiachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Otiorrhynchus sulcatus, Otiorrhynchus ovatus, Phaedon cochleariae, Phyllobius gyri, Phyllotreta chrysocephala, Phyllophaga sp., Phyllopertha horticola, Phyllotreta nemorum, Phyllotreta striolata, Popillia japonica, Sitona lineatus and Sitophilus granaria;

flies, mosquitoes (Diptera), e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Ceratitis capitata, Chrysomya bezziana, Chrysomya hominivorax, Chrysomya macellaria, Chrysops discalis, Chrysops silacea, Chrysops atlanticus, Cochliomyia hominivorax, Contarinia sorghicola Cordylobia anthropophaga, Culicoides furens, Culex pipiens, Culex nigripalpus, Culex quinquefasciatus, Culex tarsalis, Culiseta inornata, Culiseta melanura, Dacus cucurbitae, Dacus oleae, Dasineura brassicae, Delia antique, Delia coarctata, Delia platura, Delia radicum, Dermatobia hominis, Fannia canicularis, Geomyza Tripunctata, Gasterophilus intestinalis, Glossina morsitans, Glossina palpalis, Glossina fuscipes, Glossina tachinoides, Haematobia irritans, Haplodiplosis equestris, Hippelates spp., Hylemyia platura, Hypoderma lineata, Leptoconops torrens, Liriomyza sativae, Liriomyza trifolii, Lucilia caprina, Lucilia cuprina, Lucilia sericata, Lycoria pectoralis, Mansonia titillanus, Mayetiola destructor, Musca autumnalis, Musca domestica, Muscina stabulans, Oestrus ovis, Opomyza florum, Oscinella frit, Pegomya hysocyami, Phorbia antiqua, Phorbia brassicae, Phorbia coarctata, Phlebotomus argentipes, Psorophora columbiae, Psila rosae, Psorophora discolor, Prosimulium mixtum, Rhagoletis cerasi, Rhagoletis pomonella, Sarcophaga haemorrhoidalis, Sarcophaga spp., Simulium vittatum, Stomoxys calcitrans, Tabanus bovinus, Tabanus atratus, Tabanus lineola, and Tabanus similis, Tipula oleracea, and Tipula paludosa;

thrips (Thysanoptera), e.g. Dichromothrips corbetti, Dichromothrips ssp., Frankliniella fusca, Frankliniella occidentalis, Frankliniella tritici, Scirtothrips citri, Thrips oryzae, Thrips palmi and Thrips tabaci:

termites (Isoptera), e.g. Calotermes flavicollis, Leucotermes flavipes, Heterotermes aureus, Reticulitermes flavipes, Reticulitermes virginicus, Reticulitermes lucifugus, Reticulitermes santonensis, Reticulitermes grassei, Termes natalensis, and Coptotermes formosanus;

cockroaches (Blattaria—Blattodea), e.g. Blattella germanica, Blattella asahinae, Periplaneta americana, Periplaneta japonica, Periplaneta brunnea, Periplaneta fuligginosa, Periplaneta australasiae, and Blatta orientalis;

bugs, aphids, leafhoppers, whiteflies, scale insects, cicadas (Hemiptera), e.g. Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrates, Solubea insularis, Thyanta perditor, Acyrthosiphon onobrychis, Adelges laricis, Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Bemisia argentifolii, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzus persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, Viteus vitifolii, Cimex lectularius, Cimex hemipterus, Reduvius senilis, Triatoma spp., and Arilus critatus;

ants, bees, wasps, sawflies (Hymenoptera), e.g. Athalia rosae, Atta cephalotes, Atta capiguara, Atta cephalotes, Atta laevigata, Atta robusta, Atta sexdens, Atta texana, Crematogaster spp., Hoplocampa minuta, Hoplocampa testudinea, Lasius niger, Monomorium pharaonis, Solenopsis geminata, Solenopsis invicta, Solenopsis richteri, Solenopsis xyloni, Pogonomyrmex barbatus, Pogonomyrmex californicus, Pheidole megacephala, Dasymutilla occidentalis, Bombus spp., Vespula squamosa, Paravespula vulgaris, Paravespula pennsylvanica, Paravespula germanica, Dolichovespula maculata, Vespa crabro, Pastes rubiginosa, Camponotus floridanus, and Linepithema humile;

crickets, grasshoppers, locusts (Orthoptera), e.g. Acheta domestica, Gryllotalpa gryllotalpa, Locusta migratoria, Melanoplus bivittatus, Melanoplus femurrubrum, Melanoplus mexicanus, Melanoplus sanguinipes, Melanoplus spretus, Nomadacris septemfasciata, Schistocerca americana, Schistocerca gregaria, Dociostaurus maroccanus, Tachycines asynamorus, Oedaleus senegalensis, Zonozerus variegatus, Hieroglyphus daganensis, Kraussaria angulifera, Calliptamus italicus, Chortoicetes terminifera, and Locustana pardalina;

arachnoidea, such as arachnids (Acarina), e.g. of the families Argasidae, Ixodidae and Sarcoptidae, such as Amblyomma americanum, Amblyomma variegatum, Ambryomma maculatum, Argas persicus, Boophilus annulatus, Boophilus decoloratus, Boophilus microplus, Dermacentor silvarum, Dermacentor andersoni, Dermacentor variabilis, Hyalomma truncatum, Ixodes ricins, Ixodes rubicundus, Ixodes scapularis, Ixodes holocyclus, Ixodes pacificus, Ornithodorus moubata, Ornithodorus hermsi, Ornithodorus turicata, Ornithonyssus bacoti, Otobius megnini; Dermanyssus gallinae, Psoroptes ovis, Rhipicephalus sanguineus, Rhipicephalus appendiculatus, Rhipicephalus evertsi, Sarcoptes scabiei, and Eriophyidae spp. such as Aculus schlechtendai, Phyllocoptrata oleivora and Eriophyes sheldoni, Tarsonemidae spp. such as Phytonemus pallidus and Polyphagotarsonemus latus, Tenuipalpidae spp. such as Brevipalpus phoenicis; Tetranychidae spp. such as Tetranychus cinnabarinus, Tetranychus kanzawai, Tetranychus paciticus, Tetranychus telarius and Tetranychus urticae, Panonychus ulmi, Panonychus citri, and Oligonychus pratensis; Araneida, e.g. Latrodectus mactans, and Loxosceles reclusa;

fleas (Siphonaptera), e.g. Ctenocephalides fells, Ctenocephalides canis, Xenopsylla cheopis, Pulex irritans, Tunga penetrans, and Nosopsyllus fasciatus,

silverfish, firebrat (Thysanura), e.g. Lepisma saccharin and Thermobia domestica,

centipedes (Chnopoda), e.g. Scutigera coleoptrata,

millipedes (Diplopoda), e.g. Narceus spp.,

Earwigs (Dermaptera), e.g. forficula auricularia,

lice (Phthiraptera), e.g. Pediculus humanus capitis, Pediculus humanus corporis, Pthirus pubis, Haematopinus eurysternus, Haematopinus suis, Linognathus vituli, Bovicola bovis, Menopon gallinae, Menacanthus stramineus and Solenopotes capillatus.

Collembola (springtails), e.g. Onychiurus ssp.

They are also suitable for controlling Nematodes: plant parasitic nematodes such as root knot nematodes, Meladogyne hapla, Meloidogyne incognita, Meloidogyne javanica, and other Meloidogyne species; cyst-forming nematodes, Globodera rostochiensis and other Globodera species; Heterodera avenae, Heterodera glycines, Heterodera schachtii; Heterodera trifolii, and other Heterodera species; Seed gall nematodes, Anguina species; Stem and foliar nematodes, Aphelenchoides species; Sting nematodes, Belonolaimus longicaudatus and other Belonolaimus species; Pine nematodes, Bursaphelenchus xylophilus and other Bursaphelenchus species; Ring nematodes, Criconema species, Criconemella species, Criconemoides species, Mesocriconema species; Stem and bulb nematodes, Ditylenchus destructor, Ditylenchus dipsaci and other Ditylenchus species; Awl nematodes, Dolichodorus species; Spiral nematodes, Heliocotylenchus multicinctus and other Helicotylenchus species; Sheath and sheathoid nematodes, Hemicycliophora species and Hemicriconemoides species; Hirshmanniella species; Lance nematodes, Hoploaimus species; false rootknot nematodes, Nacobbus species; Needle nematodes, Longidorus elongatus and other Longidorus species; Lesion nematodes, Pratylenchus neglectus, Pratylenchus penetrans, Pratylenchus curvitatus, Pratylenchus goodeyi and other Pratylenchus species; Burrowing nematodes, Radopholus similis and other Radopholus species; Reniform nematodes, Rotylenchus robustus and other Rotylenchus species; Scutellonema species; Stubby root nematodes, Trichodorus primitivus and other Trichodorus species, Paratrichodorus species; Stunt nematodes, Tylenchorhynchus claytoni, Tylenchorhynchus dubius and other Tylenchorhynchus species; Citrus nematodes, Tylenchulus species; Dagger nematodes, Xiphinema species; and other plant parasitic nematode species.

They are also useful for controlling arachnids (Arachnoidea), such as acarians (Acarina), e.g. of the families Argasidae, Ixodidae and Sarcoptidae, such as Amblyomma americanum, Amblyomma variegatum, Argas persicus, Boophilus annulatus, Boophilus decoloratus, Boophilus microplus, Dermacentor silvarum, Hyalomma truncatum, Ixodes ricins, Ixodes rubicundus, Ornithodorus moubata, Otobius megnini, Dermanyssus gallinae, Psoroptes ovis, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni, Tarsonemidae spp. such as Phytonemus pallidus and Polyphagotarsonemus latus; Tenuipalpidae spp. such as Brevipalpus phoenicis; Tetranychidae spp. such as Tetranychus cinnabarinus, Tetranychus kanzawai, Tetranychus pacificus, Tetranychus telarius and Tetranychus urticae, Panonychus ulmi, Panonychus citri; and oligonychus pratensis.

Phytopathogenic Fungi

The pesticidal mixtures of the present invention, among them the mixtures comprising at least one compound III, have excellent activity against a broad spectrum of phytopathogenic fungi Ascomycetes, Basidiomycetes, Deuteromycetes and Peronosporomycetes (syn. Oomycetes). Some of them are systemically effective and can be employed in crop protection as foliar fungicides, as fungicides for seed dressing and as soil fungicides. They can also be used for treating seed.

They are particularly important in the control of a multitude of fungi on various cultivated plants, such as wheat, rye, barley, oats, rice, corn, lawns, bananas, cotton, soybean, coffee, sugar cane, grapevines, fruits and ornamental plants, and vegetables such as cucumbers, beans, tomatoes, potatoes and cucurbits, and on the seeds of these plants.

They are especially suitable for controlling the following plant diseases:
Alternaria species on vegetables, oilseed rape, sugar beet and fruit and rice, for example, A. solani or A. altemata on potatoes and tomatoes;
Aphanomyces species on sugar beet and vegetables;
Ascochyta species on cereals and vegetables;
Bipolaris and Drechslera species on corn, cereals, rice and lawns, for example, D. maydis on corn;
Blumeria graminis (powdery mildew) on cereals;
Botrytis cinerea (gray mold) on strawberries, vegetables, flowers and grapevines;
Bremia lactucae on lettuce;
Cercospora species on corn, soybeans, rice and sugar beet;
Cochliobolus species on corn, cereals, rice, for example Cochliobolus sativus on cereals, Cochliobolus miyabeanus on rice;
Colletotricum species on soybeans and cotton;
Drechslera species, Pyrenophora species on corn, cereals, rice and lawns, for example, D. teres on barley or D. tritici-repentis on wheat;
Esca on grapevines, caused by Phaeoacremonium chlamydosporium, Ph. Aleophilum and Formitipora punctata (syn. Phellinus punctatus);
Exserohilum species on corn;
Erysiphe cichoracearum and Sphaerotheca fuliginea on cucumbers;
Fusarium and Verticillium species on various plants, for example, F graminearum or F. culmorum on cereals or F. oxysporum on a multitude of plants, such as, for example, tomatoes;
Gaeumanomyces graminis on cereals;
Gibberella species on cereals and rice (for example Gibberella fujikuroi on rice);
Grainstaining complex on rice;
Helminthosporium species on corn and rice;
Michrodochium nivale on cereals;
Mycosphaerella species on cereals, bananas and peanuts, for example, M. graminicola on wheat or M. fijiensis on bananas;
Peronospora species on cabbage and bulbous plants, for example, P. brassicae on cabbage or P. destructor on onions;
Phakopsara pachyrhizi and Phakopsara meibomiae on soybeans;
Phomopsis species on soybeans and sunflowers;
Phytophthora infestans on potatoes and tomatoes;
Phytophthora species on various plants, for example, P. capsici on bell pepper;
Plasmopara viticola on grapevines;
Podosphaera leucotricha on apples;
Pseudocercosporella herpotrichoides on cereals;
Pseudoperonospora on various plants, for example, P. cubensis on cucumber or P. humili on hops;
Puccinia species on various plants, for example, P. triticina, P. striformins, P. hordei or P.graminis on cereals or P. asparagi on asparagus;
Pyricularia oryzae, Corticium sasakii, Sarocladium oryzae, S. attenuatum, Entyloma oryzae on rice;
Pyricularia grisea on lawns and cereals;
Pythium spp. on lawns, rice, corn, cotton, oilseed rape, sunflowers, sugar beet, vegetables and other plants, for example, P. ultiumum on various plants, P. aphanidermatum on lawns;
Rhizoctonia species on cotton, rice, potatoes, lawns, corn, oilseed rape, sugar beet, vegetables and on various plants, for example, R. solani on beet and various plants;
Rhynchosporium secalis on barley, rye and triticale;
Sclerotinia species on oilseed rape and sunflowers;
Septoria tritici and Stagonospora nodorum on wheat;
Erysiphe (syn. Uncinula) necator on grapevines;
Setospaeria species on corn and lawns;
Sphacelotheca reilinia on corn;
Thievaliopsis species on soybeans and cotton;
Tilletia species on cereals;
Ustilago species on cereals, corn and sugar cane, for example, U. maydis on corn;
Venturia species (scab) on apples and pears, for example, V. inaequalis on apples.
D.maydis species on mais, for example, C. zeae-mayidis on mais
B. zeicola species on mais, for example, C. graminicola

The pesticidal mixtures according to the invention are also suitable for controlling harmful fungi in the protection of materials (for example wood, paper, paint dispersions, fibers or fabrics) and in the protection of stored products. In the protection of wood, particular attention is paid to the following harmful fungi: Ascomycetes, such as Ophiostoma spp., Ceratocystis spp., Aureobasidium pullulans, Sclerophoma spp., Chaetomium spp., Humicola spp., Petriella spp., Trichurus spp.; Basidiomycetes, such as Coniophora spp., Coriolus spp., Gloeophyllum spp., Lentinus spp., Pleurotus spp., Poria spp., Serpula spp. and Tyromyces spp., Deuteromycetes, such as Aspergillus spp., Cladosporium spp., Penicillium spp., Trichoderma spp., Alternaria spp., Paecilomyces spp. and Zygomycetes, such as Mucor spp., additionally in the protection of materials the following yeasts: Candida spp. and Saccharomyces cerevisae.

Plant Health

The pesticidal mixture according to the invention may be used for improving the health of a plant. The invention also relates to a method for improving plant health by treating a plant, its propagation material and/or the locus where the plant is growing or is to grow with an effective amount of the pesticidal mixture according to the invention. The term “plant health” is to be understood to denote a condition of the plant and/or its products which is determined by several indicators alone or in combination with each other such as yield (e.g. increased biomass and/or increased content of valuable ingredients of the plant), plant vigor (e.g. improved plant growth and/or greener leaves (“greening effect”)), quality (e.g. improved content or composition of certain ingredients of the plant) and tolerance to abiotic and/or biotic stress. The above identified indicators for the health condition of a plant may be interdependent or may result from each other.

Formulations

The pesticidal mixtures according to the present invention can be converted into the customary formulations, for example solutions, emulsions, suspensions, dusts, powders, pastes and granules. The use form depends on the particular intended purpose; in each case, it should ensure a fine and even distribution of the compounds according to the invention.

The formulations may be prepared in a known manner (see e.g. for review U.S. Pat. No. 3,060,084, EP-A 707 445 (for liquid concentrates), Browning, “Agglomeration”, Chemical Engineering, Dec. 4, 1967, 147-48, Perry's Chemical Engineer's Handbook, 4th Ed., McGraw-Hill, New York, 1963, pages 8-57 and et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Germany), 2001, 2. D. A. Knowles, Chemistry and Technology of Agrochemical Formulations, Kluwer Academic Publishers, Dordrecht, 1998 (ISBN 0-7514-0443-8), for example by extending the active compound with auxiliaries suitable for the formulation of agrochemicals, such as solvents and/or carriers, if desired emulsifiers, surfactants and dispersants, preservatives, anti-foaming agents, anti-freezing agents, for seed treatment formulation also optionally gelling agents.

Examples of suitable solvents are water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP(N-methyl-pyrrolidone), NOP (N-octyl-pyrrolidone)), acetates (glycol diacetate), glycols, fatty acid dimethylamides, fatty acids and fatty acid esters. In principle, solvent mixtures may also be used.

Suitable emulsifiers are nonionic and anionic emulsifiers (for example polyoxyethylene fatty alcohol ethers, alkylsulfonates and arylsulfonates).

Examples of dispersants are lignin-sulfite waste liquors and methylcellulose.

Suitable surfactants used are alkali metal, alkaline earth metal and ammonium salts of lignosulfonic acid, naphthalenesulfonic acid, phenolsulfonic acid, dibutylnaphthalene-sulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ether, ethoxylated isooctylphenol, octylphenol, nonylphenol, alkylphenol polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone or water.

Also anti-freezing agents such as glycerin, ethylene glycol, propylene glycol and bactericides such as can be added to the formulation.

Suitable antifoaming agents are for example antifoaming agents based on silicon or magnesium stearate.

A suitable preservative is e.g. dichlorophen.

An example of a gelling agent is carrageen (Satiagel®)

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers.

Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of active ingredients. In this case, the active ingredients are employed in a purity of from 90% to 100% by weight, preferably 95% to 100% by weight (according to NMR spectrum).

For seed treatment purposes, respective formulations can be diluted 2-10 fold leading to concentrations in the ready to use preparations of 0.01 to 60% by weight active ingredients by weight, preferably 0.1 to 40% by weight.

The mixtures of the present invention can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. However, it is also possible to prepare concentrates composed of active substance, wetter, tackifier, dispersant or emulsifier and, if appropriate, solvent or oil, and such concentrates are suitable for dilution with water.

The active ingredients cyanosulfoximine and spinetoram concentrations in the ready-to-use preparations can be varied within relatively wide ranges. In general, they are from 0.0001 to 10%, preferably from 0.01 to 1% per weight.

The active ingredients cyanosulfoximine and spinetoram may also be used successfully in the ultra-low-volume process (ULV), it being possible to apply formulations comprising over 95% by weight of active compound, or even to apply the active compound without additives.

The following are examples of formulations:

1. Products for dilution with water for foliar applications. For seed treatment purposes, such products may be applied to the seed diluted or undiluted.

A) Water-Soluble Concentrates (SL, LS)

10 parts by weight of the active ingredients are dissolved in 90 parts by weight of water or a water-soluble solvent. As an alternative, wetters or other auxiliaries are added. The active ingredient(s) dissolve(s) upon dilution with water, whereby a formulation with 10% (w/w) of active compound(s) is obtained.

B) Dispersible Concentrates (DC)

20 parts by weight of the active ingredient(s) are dissolved in 70 parts by weight of cyclohexanone with addition of 10 parts by weight of a dispersant, for example polyvinylpyrrolidone. Dilution with water gives a dispersion, whereby a formulation with 20% (w/w) of active ingredient(s) is obtained.

C) Emulsifiable Concentrates (EC)

15 parts by weight of the active ingredient(s) are dissolved in 7 parts by weight of xylene with addition of calcium dodecylbenzenesulfonate and castor oil ethoxylate (in each case 5 parts by weight). Dilution with water gives an emulsion, whereby a formulation with 15% (w/w) of active ingredient(s) is obtained.

D) Emulsions (EW, EO, ES)

25 parts by weight of the active ingredient(s) are dissolved in 35 parts by weight of xylene with addition of calcium dodecylbenzenesulfonate and castor oil ethoxylate (in each case 5 parts by weight). This mixture is introduced into 30 parts by weight of water by means of an emulsifier machine (e.g. Ultraturrax) and made into a homogeneous emulsion. Dilution with water gives an emulsion, whereby a formulation with 25% (w/w) of active ingredient(s) is obtained.

E) Suspensions (SC, OD, FS)

In an agitated ball mill, 20 parts by weight of the active ingredient(s) are comminuted with addition of 10 parts by weight of dispersants, wetters and 70 parts by weight of water or of an organic solvent to give a fine active ingredient(s) suspension. Dilution with water gives a stable suspension of the active ingredient(s), whereby a formulation with 20% (w/w) of active ingredient(s) is obtained.

F) Water-Dispersible Granules and Water-Soluble Granules (WG, SG)

50 parts by weight of the active ingredient(s) are ground finely with addition of 50 parts by weight of dispersants and wetters and made as water-dispersible or water-soluble granules by means of technical appliances (for example extrusion, spray tower, fluidized bed). Dilution with water gives a stable dispersion or solution of the active ingredient(s), whereby a formulation with 50% (w/w) of active ingredient(s) is obtained.

G) Water-Dispersible Powders and Water-Soluble Powders (WP, SP, SS, WS)

75 parts by weight of the active ingredient(s) are ground in a rotor-stator mill with addition of 25 parts by weight of dispersants, wetters and silica gel. Dilution with water gives a stable dispersion or solution of the active ingredient(s), whereby a formulation with 75% (w/w) of active ingredient(s) is obtained.

H) Gel-Formulation (GF)

In an agitated ball mill, 20 parts by weight of the active ingredient(s) are comminuted with addition of 10 parts by weight of dispersants, 1 part by weight of gelling agent wetters and 70 parts by weight of water or of an organic solvent to give a fine active ingredient(s) suspension. Dilution with water gives a stable suspension of the active ingredient(s), whereby a formulation with 20% (w/w) of active ingredient(s) is obtained.

2. Products to be applied undiluted for foliar applications. For seed treatment purposes, such products may be applied to the seed diluted or undiluted.

I) Dustable Powders (DP, DS)

5 parts by weight of the active ingredient(s) are ground finely and mixed intimately with 95 parts by weight of finely divided kaolin. This gives a dustable product having 5% (w/w) of active ingredient(s).

J) Granules (GR, FG, GG, MG)

0.5 part by weight of the active ingredient(s) is ground finely and associated with 95.5 parts by weight of carriers, whereby a formulation with 0.5% (w/w) of active ingredient(s) is obtained. Current methods are extrusion, spray-drying or the fluidized bed. This gives granules to be applied undiluted for foliar use.

K) ULV Solutions (UL)

10 parts by weight of the active ingredient(s) are dissolved in 90 parts by weight of an organic solvent, for example xylene. This gives a product having 10% (w/w) of active ingredient(s), which is applied undiluted for foliar use.

Various types of oils, wetters, adjuvants, herbicides, fungicides, other pesticides, or bactericides may be added to the active ingredients, if appropriate just immediately prior to use (tank mix). These agents usually are admixed with the agents according to the invention in a weight ratio of 1:10 to 10:1.

The pesticidal mixtures of this invention e.g. in form of compositions may further contain other active ingredients than those listed above. For example further insecticides or fungicides, herbicides, fertilizers such as ammonium nitrate, urea, potash, and superphosphate, phytotoxicants and plant growth regulators and safeners. These agents usually are admixed with the agents according to the invention in a weight ratio of 1:10 to 10:1.

The pesticidal mixtures may comprise additionally one or more further insecticidal compound IV of the following list M of pesticides. The list is intended to illustrate the possible combinations, but not to impose any limitation:

IV M.1. Organo(thio)phosphates: acephate, azamethiphos, azinphos-ethyl, azinphos-methyl, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, flupyrazophos, fosthiazate, heptenophos, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion;

IV M.2. Carbamates: aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, triazamate;

IV M.3. Pyrethroids: acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-, yfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, permethrin, phenothrin, prallethrin, resmethrin, RU 15525, silafluofen, tefluthrin, tetramethrin, tralomethrin, transfluthrin, ZXI 8901;

IV M.4. Juvenile hormone mimics: hydroprene, kinoprene, methoprene, fenoxycarb, pyriproxyfen;

IV M.5. Nicotinic receptor agonists/antagonists compounds: acetamiprid, bensultap, cartap hydrochloride, clothianidin, dinotefuran, imidacloprid, thiamethoxam, nitenpyram, nicotine, spinosad (allosteric agonist), thiacloprid, thiocyclam, thiosultap-sodium and AKD1022;

IV M.6. GABA gated chloride channel antagonist compounds: chlordane, endosulfan, gamma-HCH (lindane); acetoprole, ethiprole, fipronil, pyrafluprole, pyriprole, vaniliprole, the phenylpyrazole compound of formula M^{6.1};

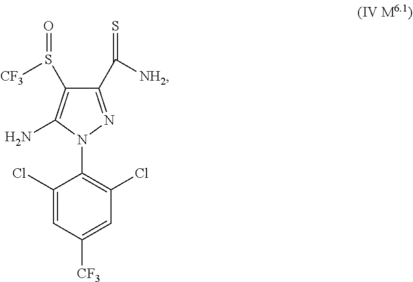

IV M.7. Chloride channel activators: abamectin, emamectin benzoate, milbemectin, lepimectin;

IV M.8. METI I compounds: fenazaquin, fenpyroximate, pyrimidifen, pyridaben, tebufenpyrad, tolfenpyrad, flufenerim, rotenone;

IV M.9. METI II and IV compounds: acequinocyl, fluacyprim, hydramethylnon;

IV M.10. Uncouplers of oxidative phosphorylation: chlorfenapyr, DNOC;

IV M.11. Inhibitors of oxidative phosphorylation: azocyclotin, cyhexatin, diafenthiuron, fenbutatin oxide, propargite, tetradifon;

IV M.12. Moulting disruptors: cyromazine, chromafenozide, halofenozide, methoxyfenozide, tebufenozide;

IV M.13. Synergists: piperonyl butoxide, tribufos;

IV M.14. Sodium channel blocker compounds: indoxacarb, metaflumizone;

IV M.15. Fumigants: methyl bromide, chloropicrin sulfuryl fluoride;

IV M.16. Selective feeding blockers: crylotie, pymetrozine, flonicamid;

IV M.17. Mite growth inhibitors: clofentezine, hexythiazox, etoxazole;

IV M.18. Chitin synthesis inhibitors: buprofezin, bistrifluron, chlorfluazuron, diflubenzuron, flucycloxuron, flufenoxuron, hexaflumuron, lufenuron, novaluron, noviflumuron, teflubenzuron, triflumuron;

IV M.19. Lipid biosynthesis inhibitors: spirodiclofen, spiromesifen, spirotetramat;

IV M.20. octapaminergic agonsits: amitraz;

IV M.21. ryanodine receptor modulators: flubendiamide;

IV M.22. Various: aluminium phosphide, amidoflumet, benclothiaz, benzoximate, bifenazate, borax, bromopropylate, cyanide, cyenopyrafen, cyflumetofen, chinomethionate, dicofol, fluoroacetate, phosphine, pyridalyl, pyrifluquinazon, sulfur, tartar emetic; pyrimidinyl alkynylether compounds M^{22.1} or thiadiazolyl alkynylether compounds M^{22.2};

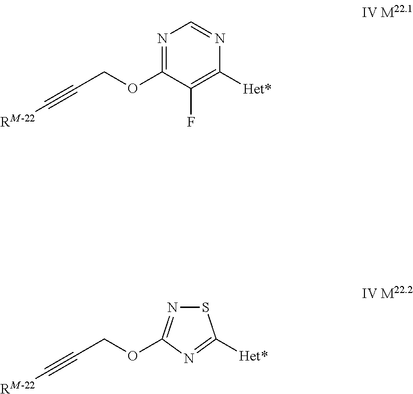

wherein R^{M-22} is methyl or ethyl and Het* is 3,3-dimethylpyrrolidin-1-yl, 3-methylpiperidin-1-yl, 3,5-dimethylpiperidin-1-yl, 3-trifluormethylpiperidin-1-yl, hexahydroazepin-1-yl, 2,6-dimethylhexahydroazepin-1-yl or 2,6-dimethylmorpholin-4-yl.

IV M.23. N-R′-2,2-dihalo-1-R″cyclo-propanecarboxamide-2-(2,6-dichloro-α,α,α-trifluoro-p-tolyphydrazone or N-R′-2,2-di(R′″)propionamide-2-(2,6-dichloro-α,α,α-trifluoro-p-tolyl)-hydrazone, wherein R′ is methyl or ethyl, halo is chloro or bromo, R″ is hydrogen or methyl and R′″ is methyl or ethyl;

IV M.24. Anthranilamides: chloranthraniliprole, the compound of formula M²⁴ 1

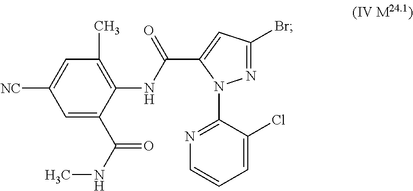

IV M.25. Malononitrile compounds: CF₃(CH₂)₂C(CN)₂CH₂(CF₂)₃CF₂H, CF₃(CH₂)₂C(CN)₂CH₂(CF₂)₅CF₂H, CF₃(CH₂)₂C(CN)₂(CH₂)₂C(CF₃)₂F, CF₃(CH₂)₂C(CN)₂(CH₂)₂(CF₂)₃CF₃, CF₂H(CF₂)₃CH₂C(CN)₂CH₂(CF₂)₃CF₃H, CF₃(CH₂)₂C(CN)₂CH₂(CF₂)₃CF₃, CF₃(CF₂)₂CH₂C(CN)₂CH₂(CF₂)₃CF₂H, CF₃CF₂CH₂C(CN)₂CH₂(CF₂)₃CF₂H, 2-(2,2,3,3,4,4,5,5-octafluoropentyl)-2-(3,3,4,4,4-pentafluorobutyl)-malonodinitrile, and CF₂HCF₂CF₂CF₂CH₂C(CN)₂CH₂CH₂CF₂CF₃;

IV M.26. Microbial disruptors: Bacillus thuringiensis subsp. Israelensi, Bacillus sphaericus, Bacillus thuringiensis subsp. Aizawai, Bacillus thuringiensis subsp. Kurstaki, Bacillus thuringiensis subsp. Tenebrionis;

The commercially available compounds IV of the group M may be found in The Pesticide Manual, 13th Edition, British Crop Protection Council (2003) among other publications.

Thioamides of formula IV M^{6.1} and their preparation have been described in WO 98/28279. Lepimectin is known from Agro Project, PJB Publications Ltd, November 2004. Benclothiaz and its preparation have been described in EP-A1 454621. Methidathion and Paraoxon and their preparation have been described in Farm Chemicals Handbook, Volume 88, Meister Publishing Company, 2001. Acetoprole and its preparation have been described in WO 98/28277. Metaflumizone and its preparation have been described in EP-A1 462 456. Flupyrazofos has been described in Pesticide Science 54, 1988, p. 237-243 and in U.S. Pat. No. 4,822,779. Pyrafluprole and its preparation have been described in JP 2002193709 and in WO 01/00614. Pyriprole and its preparation have been described in WO 98/45274 and in U.S. Pat. No. 6,335,357. Amidoflumet and its preparation have been described in U.S. Pat. No. 6,221,890 and in JP 21010907. Flufenerim and its preparation have been described in WO 03/007717 and in WO 03/007718. AKD 1022 and its preparation have been described in U.S. Pat. No. 6,300,348. Chloranthraniliprole has been described in WO 01/70671, WO 03/015519 and WO 05/118552. Anthranilamide derivatives of formula M^{24.1} have been described in WO 01/70671, WO 04/067528 and WO 05/118552. Cyflumetofen and its preparation have been described in WO 04/080180. The aminoquinazolinone compound pyrifluquinazon has been described in EP A 109 7932. The alkynylether compounds IV M^{22.1} and IV M^{22.2} are described e.g. in JP 2006131529. The malononitrile compounds CF₃(CH₂)₂C(CN)₂CH₂(CF₂)₃CF₂H, CF₃(CH₂)₂C(CN)₂CH₂(CF₂)₅CF₂H, CF₃(CH₂)₂C(CN)₂(CH₂)₂C(CF₃)₂F, CF₃(CH₂)₂C(CN)₂(CH₂)₂(CF₂)₃CF₃, CF₂H(CF₂)₃CH₂C(CN)₂CH₂(CF₂)₃CF₂H, CF₃(CH₂)₂C(CN)₂CH₂(CF₂)₃CF₃, CF₃(CF₂)₂CH₂C(CN)₂CH₂(CF₂)₃CF₂H, CF₃CF₂CH₂C(CN)₂CH₂(CF₂)₃CF₂H, 2-(2,2,3,3,4,4,5,5-octafluoropentyl)-2-(3,3,4,4,4-pentafluorobutyl)-malonodinitrile, and CF₂HCF₂CF₂CF₂CH₂C(CN)₂CH₂CH₂CF₂CF₃ have been described in WO 05/63694.

Those additional active ingredients may be used sequentially or in combination with the above-described compositions, if appropriate also added only immediately prior to use (tank mix). For example, the plant(s) may be sprayed with a composition of this invention either before or after being treated with other active ingredients.

Applications

The compounds constituting the pesticidal mixtures according to the invention e.g. cyanosulfoximine active compound(s) I and the spinetoram and optionally the one or more active compound(s) II or III can be applied according to different ways of applications, which are
A) simultaneously, that is
   a1) jointly (i.e. as mixture as such, e.g. a ready-to-use-formulation, or as tank mix) or
   a2) separately (i.e. application via separate tanks), or
B) in succession separately, the sequence, in this case, generally not having any effect on the result of the control measures.

Therefore, the method for controlling harmful fungi and/or animal pests is carried out by the separate or joint application of the different compounds constituting the pesticidal mixture as defined in the invention, by spraying or dusting the seeds, the plants or the soils before or after sowing of the plants or before or after emergence of the plants.

Usually, mixtures of at least one compound I and spinetoram and optionally at least one active compound II or III are employed. However, mixtures of at least one compound I and spinetoram with two or, if desired, further more active components may also offer particular advantages.

Suitable further active components in the above sense are particularly the active compounds II or III mentioned at the outset and in particular the preferred active compounds II or the preferred active compounds III mentioned above.

Pesticidal mixtures of this invention, in particular in form of compositions of this invention may further contain other active ingredients than those listed above. In general, the term “active ingredient” means in the present invention compounds having a pesticidal activity. For example fungicides, herbicides, fertilizers such as ammonium nitrate, urea, potash, and superphosphate, phytotoxicants and plant growth regulators and safeners. Additional ingredients may be used sequentially or in combination with the above-described compositions, if appropriate also added only immediately prior to use (tank mix). For example, the plant(s) may be sprayed with a composition of this invention either before or after being treated with other active ingredients.

The method of preparation of the pesticidal mixtures according to the invention will depend on wether they are applied simultaneously that is jointly or separately. The pesticidal mixtures may be prepared by any suitable methods, for instance mixing all of the components e.g. actives compounds or by preparing a premixture of two or more components e.g. active ingredients and then adding further components e.g. active ingredient(s).

The pesticidal mixtures of the present invention are employed as such or in form of compositions by treating the arthropods e.g. insects, the harmful fungi or the plants, plant propagation materials, such as seeds, soil, surfaces, materials or rooms to be protected from insecticidal attack with a pesticidally effective amount of the active compounds. The application can be carried out both before and after the infection by the pest e.g. the harmful fungi and/or animal pest of for example the plants, plant propagation materials, such as seeds, soil, surfaces, materials or rooms by the respective pest.

The present invention also includes a method of combating pests which comprises contacting the animal pests, their habit, breeding ground, food supply, cultivated plants, seed, soil, area, material or environment in which the animal pests are growing or may grow, or the materials, plants, seeds, soils, surfaces or spaces to be protected from animal attack or infestation with a pesticidally effective amount of a pesticidal mixture according to the invention in particular those comprising one or more active compound II.

The inventive pesticidal mixtures or compositions of these mixtures can also be employed for protecting plants from attack or infestation by arthropodes e.g. insects, arachnids or nematodes comprising contacting a plant, or soil or water in which the plant is growing.

Preferred application methods are into water bodies, via soil, cracks and crevices, pastures, manure piles, sewers, into water, on floor, wall, or by perimeter spray application and bait.

Some of the inventive mixtures have systemic action and can therefore be used for the protection of the plant shoot against foliar pests as well as for the treatment of the seed and roots against soil pests.

In general, “pesticidally effective amount” means the amount of the inventive pesticidal mixtures or of compositions comprising the pesticidal mixtures needed to achieve an observable effect on growth, including the effects of necrosis, death, retardation, prevention, and removal, destruction, or otherwise diminishing the occurrence and activity of the target organism. The pesticidally effective amount can vary for the various mixtures/compositions used in the invention. A pesticidally effective amount of the mixtures/compositions will also vary according to the prevailing conditions such as desired pesticidal effect and duration, weather, target species, locus, mode of application, and the like.

The inventive pesticidal mixtures e.g. in form of compositions can for instance be used for protecting wooden materials such as trees, board fences, sleepers, etc. and buildings such as houses, outhouses, factories, but also construction materials, furniture, leathers, fibers, vinyl articles, electric wires and cables etc. from ants and/or termites, and for controlling ants and termites from doing harm to crops or human being (e.g. when the pests invade into houses and public facilities).

In the case of soil treatment or of application to the pests dwelling place or nest, the quantity of active ingredient(s) ranges from 0.0001 to 500 g per 100 m², preferably from 0.001 to 20 g per 100 m².

Customary application rates in the protection of materials are, for example, from 0.01 g to 1000 g of active ingredient(s) per m² treated material, desirably from 0.1 g to 50 g per m².

Pesticidal mixtures for use in the impregnation of materials e.g. in form of compositions typically contain from 0.001 to 95 weight %, preferably from 0.1 to 45 weight %, and more preferably from 1 to 25 weight % of at least one repellent and/or insecticide.

For use in spray compositions, the content of the mixture of the active ingredients is from 0.001 to 80 weights %, preferably from 0.01 to 50 weight % and most preferably from 0.01 to 15 weight %.

In general, “synergistically effective amount” means that the one or more active compound(s) I and the spinetoram are usually applied in a weight ratio of from 500:1 to 1:100, preferably from 20:1 to 1:50, in particular from 5:1 to 1:20. Depending on the nature of the compounds the employed weight ratio of compound(s) I and spinetoram ranges can start from 100:1 to 1:100, preferably from 20:1 to 1:20, in particular from 10:1 to 1:10.

Further active compounds II or III are, if desired, employed in a ratio of from 20:1 to 1:20 to Mα or Mβ or to the different active compounds.

Depending on the desired effect, the application rates of the pesticidal mixtures according to the invention are from 5 g/ha to 2000 g/ha, preferably from 20 to 1500 g/ha, more preferably from 50 to 1000 g/ha and in particular from 50 to 750 g/ha.

For use in treating crop plants, the rate of application of the pesticidal mixture of the active ingredients of this invention may be in the range of 0.1 g to 4000 g per hectare, desirably from 25 g to 600 g per hectare, more desirably from 50 g to 500 g per hectare.

Correspondingly, the application rates for the compound(s) I or spinetoram are generally from 1 to 1000 g/ha, preferably from 10 to 900 g/ha, in particular from 20 to 500 g/ha.

Correspondingly, the application rates for the active compound(s) II or III are generally from 1 to 2000 g/ha, preferably from 10 to 1500 g/ha, in particular from 40 to 1000 g/ha.

Methods to control infectious diseases transmitted by insects (e.g. malaria, dengue and yellow fever, lymphatic filariasis, and leishmaniasis) with the inventive mixtures and their respective compositions also comprise treating surfaces of huts and houses, air spraying and impregnation of curtains, tents, clothing items, bed nets, tsetse-fly trap or the like. Insecticidal compositions for application to fibers, fabric, knitgoods, non-wovens, netting material or foils and tarpaulins preferably comprise a composition including the inventive mixtures, optionally a repellent and at least one binder.

Bait Formulations and Applications

The pesticidal mixtures according to the invention can be applied to any and all developmental stages, such as egg, larva, pupa, and adult. The pests may be controlled by contacting the target pest, its food supply, habitat, breeding ground or its locus with a pesticidally effective amount of the inventive mixtures or of compositions comprising the mixtures.

“Locus” in general means a plant, seed, soil, area, material or environment in which pests or fungi are growing or may grow.

The inventive mixtures are effective through both contact (via soil, glass, wall, bed net, carpet, plant parts or animal parts), and ingestion (bait, or plant part) and through trophallaxis and transfer.

According to a preferred embodiment of the invention, the mixtures according to the present invention are employed via soil application. Soil application is especially favorable for use against ants, termites, crickets, or cockroaches.

According to another preferred embodiment of the invention, for use against non crop pests such as ants, termites, wasps, flies, mosquitoes, crickets, locusts, or cockroaches the mixtures according to the present invention are prepared into a bait preparation.

The mixtures according to the invention are effective through both contact and ingestion.

According to a preferred embodiment of the invention, the mixtures according to the present invention are employed via soil application. Soil application is especially favorable for use against ants, termites, crickets, or cockroaches.

According to another preferred embodiment of the invention, for use against non crop pests such as ants, termites, wasps, flies, mosquitoes, crickets, locusts, or cockroaches the mixtures according to the present invention are prepared into a bait preparation.

The bait can be a liquid, a solid or a semisolid preparation (e.g. a gel). The bait employed in the composition is a product which is sufficiently attractive to incite insects such as ants, termites, wasps, flies, mosquitoes, crickets etc. or cockroaches to eat it. This attractant may be chosen from feeding stimulants or para and/or sex pheromones readily known in the art.

For use in bait compositions, the typical content of active ingredient(s) is from 0.0001 weight % to 15 weight %, desirably from 0.001 weight % to 5% weight % of active ingredient(s). The bait composition used may also comprise other additives such as a solvent of the active material, a flavoring agent, a preserving agent, a dye or a bitter agent. Its attractiveness may also be enhanced by a special color, shape or texture.

Application to and Treatment of Plants

For use in spray compositions, the content of the mixture of the active ingredients is from 0.001 to 80 weights %, preferably from 0.01 to 50 weight % and most preferably from 0.01 to 15 weight %.

For use in treating crop plants, the rate of application of the mixture of the active ingredients of this invention may be in the range of 0.1 g to 4000 g per hectare, desirably from 25 g to 600 g per hectare, more desirably from 50 g to 500 g per hectare.

In the context of the present invention, the term plant refers to an entire plant, a part of the plant or the propagation material of the plant.

The pesticidal mixtures of the present invention e.g. in form of compositions are particularly important in the control of a multitude of pests such as insects on various cultivated plants, such as cereal, root crops, oil crops, vegetables, spices, ornamentals, for example seed of durum and other wheat, barley, oats, rye, maize (fodder maize and sugar maize/sweet and field corn), soybeans, oil crops, crucifers, cotton, sunflowers, bananas, rice, oilseed rape, turnip rape, sugarbeet, fodder beet, eggplants, potatoes, grass, lawn, turf, fodder grass, tomatoes, leeks, pumpkin/squash, cabbage, iceberg lettuce, pepper, cucumbers, melons, Brassica species, melons, beans, peas, garlic, onions, carrots, tuberous plants such as potatoes, sugar cane, tobacco, grapes, petunias, geranium/pelargoniums, pansies and impatiens.

Plants which can be treated with the inventive mixtures include beside the natural plants all genetically modified plants or transgenic plants, e.g. crops which tolerate the action of herbicides or fungicides or insecticides owing to breeding, including genetic engineering methods, or plants which have modified characteristics in comparison with existing plants, which can be generated for example by traditional breeding methods and/or the generation of mutants, or by recombinant procedures.

The term “plant propagation material” is to be understood to denote all the generative parts of the plant such as seeds and vegetative plant material such as cuttings and tubers (e. g. potatoes), which can be used for the multiplication of the plant. This includes seeds, roots, fruits, tubers, bulbs, rhizomes, shoots, sprouts and other parts of plants. Seedlings and young plants, which are to be transplanted after germination or after emergence from soil, may also be included. These plant propagation materials may be treated prophylactically with a plant protection compound either at or before planting or transplanting.

The term “cultivated plants” is to be understood as including plants which have been modified by breeding, mutagenesis or genetic engineering. Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-transtional modification of protein(s) (oligo- or polypeptides) poly for example by glycosylation or polymer additions such as prenylated, acetylated or farnesylated moieties or PEG moieties(e.g. as disclosed in Biotechnol Prog. July-August 2001; 17(4):720-8., Protein Eng Des Sel. January 2004; 17(1):57-66, Nat Protoc. 2007; 2(5):1225-35., Curr Opin Chem Biol. October 2006; 10(5):487-91. Epub Aug. 28, 2006, Biomaterials. March 2001; 22(5):405-17, Bioconjug Chem. January-February 2005; 16(1):113-21).

The term “cultivated plants” is to be understood also including plants that have been rendered tolerant to applications of specific classes of herbicides, such as hydroxy-phenylpyruvate dioxygenase (HPPD) inhibitors; acetolactate synthase (ALS) inhibitors, such as sulfonyl ureas (see e. g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073) or imidazolinones (see e. g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073); enolpyruvylshikimate-3-phosphate synthase (EPSPS) inhibitors, such as glyphosate (see e. g. WO 92/00377); glutamine synthetase (GS) inhibitors, such as glufosinate (see e. g. EP-A-0242236, EP-A-242246) or oxynil herbicides (see e. g. U.S. Pat. No. 5,559,024) as a result of conventional methods of breeding or genetic engineering. Several cultivated plants have been rendered tolerant to herbicides by conventional methods of breeding (mutagenesis), for example Clearfield® summer rape (Canola) being tolerant to imidazolinones, e. g. imazamox. Genetic engineering methods have been used to render cultivated plants, such as soybean, cotton, corn, beets and rape, tolerant to herbicides, such as glyphosate and glufosinate, some of which are commercially available under the trade names RoundupReady® (glyphosate) and LibertyLink® (glufosinate).

The term “cultivated plants” is to be understood also including plants that are by the use of recombinant DNA techniques capable to synthesize one or more insecticidal proteins, especially those known from the bacterial genus Bacillus, particularly from Bacillus thuringiensis, such as 5-endotoxins, e. g. CryIA(b), CryIA(c), CryIF, CryIF(a2), CryIIA(b), CryIIIA, CryIIIB(b1) or Cry9c; vegetative insecticidal proteins (VIP), e. g. VIP1, VIP2, VIP3 or VIP3A; insecticidal proteins of bacteria colonizing nematodes, for example Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, for example WO 02/015701). Further examples of such toxins or genetically-modified plants capable of synthesizing such toxins are dis-closed, for example, in EP-A 374 753, WO 93/007278, WO 95/34656, EP-A 427 529, EP-A 451 878, WO 03/018810 and WO 03/052073. The methods for producing such genetically modified plants are generally known to the person skilled in the art and are described, for example, in the publications mentioned above. These insecticidal proteins contained in the genetically modified plants impart to the plants producing these proteins protection from harmful pests from certain taxonomic groups of arthropods, particularly to beetles (Coleoptera), flies (Diptera), and butterflies and moths (Lepidoptera) and to plant parasitic nematodes (Nematoda).

The term “cultivated plants” is to be understood also including plants that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, for example EP-A 0 392 225), plant disease resistance genes (for example potato cultivars, which express resistance genes acting against Phytophthora infestans derived from the mexican wild potato Solanum bulbocastanum) or T4-lyso-zym (e. g. potato cultivars capable of synthesizing these proteins with increased resistance against bacteria such as Erwinia amylvora). The methods for producing such genetically modified plants are generally known to the person skilled in the art and are described, for example, in the publications mentioned above.

The term “cultivated plants” is to be understood also including plants that are by the use of recombinant DNA techniques capable to synthesize one or more proteins to increase the productivity (e. g. bio mass production, grain yield, starch content, oil content or protein content), tolerance to drought, salinity or other growth-limiting environ-mental factors or tolerance to pests and fungal, bacterial or viral pathogens of those plants.

The term “cultivated plants” is to be understood also including plants that contain by the use of recombinant DNA techniques a modified amount of substances of content or new substances of content, specifically to improve human or animal nutrition, for ex-ample oil crops that produce health-promoting long-chain omega-3 fatty acids or unsaturated omega-9 fatty acids (e. g. Nexera® rape).

The term “cultivated plants” is to be understood also including plants that contain by the use of recombinant DNA techniques a modified amount of substances of content or new substances of content, specifically to improve raw material production, for example potatoes that produce increased amounts of amylopectin (e. g. Amflora® potato).

Some of the inventive mixtures have systemic action and can therefore be used for the protection of the plant shoot against foliar pests as well as for the treatment of the seed and roots against soil pests.

Seed Treatment

The mixtures according to the present invention are therfore also suitable for the treatment of seeds in order to protect the seed from pests in particular insect pest, in particular from soil-living insect pests and the resulting plant's roots and shoots against soil pests and foliar insects.

The protection of the resulting plant's roots and shoots is preferred.

More preferred is the protection of resulting plant's shoots from piercing and sucking insects.

The present invention therefore comprises a method for the protection of seeds from insects, in particular from soil insects and of the seedlings' roots and shoots from insects, in particular from soil and foliar insects, said method comprising contacting the seeds before sowing and/or after pregermination with pesticidal mixtures according to the present invention. Particularly preferred is a method, wherein the plant's roots and shoots are protected, more preferably a method, wherein the plants shoots are protected form piercing and sucking insects, most preferably a method, wherein the plants shoots are protected from aphids.

The term seed embraces seeds and plant propagules of all kinds including but not limited to true seeds, seed pieces, suckers, corms, bulbs, fruit, tubers, grains, cuttings, cut shoots and the like and means in a preferred embodiment true seeds.

The term seed treatment comprises all suitable seed treatment techniques known in the art, such as seed dressing, seed coating, seed dusting, seed soaking and seed pelleting.

The present invention also comprises seeds coated with or containing the pesticidal mixture(s) according to the invention. The term “coated with and/or containing” generally signifies that the active ingredient(s) are for the most part on the surface of the propagation product at the time of application, although a greater or lesser part of the ingredient may penetrate into the propagation product, depending on the method of application. When the said propagation products are (re)planted, it may absorb the active ingredient.

Suitable seeds are seeds of cereals, root crops, oil crops, vegetables, spices, ornamentals, for example seed of durum and other wheat, barley, oats, rye, maize (fodder maize and sugar maize/sweet and field corn), soybeans, oil crops, crucifers, cotton, sunflowers, bananas, rice, oilseed rape, turnip rape, sugarbeet, fodder beet, eggplants, potatoes, grass, lawn, turf, fodder grass, tomatoes, leeks, pumpkin/squash, cabbage, iceberg lettuce, pepper, cucumbers, melons, Brassica species, melons, beans, peas, garlic, onions, carrots, tuberous plants such as potatoes, sugar cane, tobacco, grapes, petunias, geranium/pelargoniums, pansies and impatiens.

In addition, the pesticidal mixtures according to the invention may also be used for the treatment seeds from plants, which tolerate the action of herbicides or fungicides or insecticides owing to breeding, including genetic engineering methods.

For example, the active mixtures can be employed in treatment of seeds from plants, which are resistant to herbicides from the group consisting of the sulfonylureas, imidazolinones, glufosinate-ammonium or glyphosate-isopropylammonium and analogous active substances (see for example, EP-A-0242236, EP-A-242246) (WO 92/00377) (EP-A-0257993, U.S. Pat. No. 5,013,659) or in transgenic crop plants, for example cotton, with the capability of producing Bacillus thuringiensis toxins (Bt toxins) which make the plants resistant to certain pests (EP-A-0142924, EP-A-0193259),

Furthermore, the mixtures according to the present invention can be used also for the treatment of seeds from plants, which have modified characteristics in comparison with existing plants consist, which can be generated for example by traditional breeding methods and/or the generation of mutants, or by recombinant procedures). For example, a number of cases have been described of recombinant modifications of crop plants for the purpose of modifying the starch synthesized in the plants (e.g. WO 92/11376, WO 92/14827, WO 91/19806) or of transgenic crop plants having a modified fatty acid composition (WO 91/13972).

The seed treatment application of the mixtures is generally carried out by spraying or by dusting the seeds before sowing of the plants and before emergence of the plants. The method of fumigation can also be applied. The term fumigation in this context means the use of a pesticidal mixture or composition according to the invention that can be volatilized/dispersed in the form of ultra small volume dropets (smokes) or vapors to control pest in storage bins, buildings, greenhouses, ships, railcars, stored products, on foods, plants, other living organisms, or in any closed areas which are prone to attack by pests, i.e., pest infestation.

In the treatment of seeds the corresponding formulations are applied by treating the seeds with an effective amount of the mixture according to the present invention. Herein, the application rates of the active compound(s) are generally from 0.1 g to 10 kg per 100 kg of seed, preferably from 1 g to 5 kg per 100 kg of seed, in particular from 1 g to 2.5 kg per 100 kg of seed. For specific crops such as lettuce the rate can be higher.

Compositions, which are especially useful for seed treatment are e.g.:

A Water-soluble concentrates (SL, LS)

D Emulsions (EW, EO, ES)

E Suspensions (SC, OD, FS)

F Water-dispersible granules and water-soluble granules (WG, SG)

G Water-dispersible powders and water-soluble powders (WP, SP, WS)

H Gel-Formulations (GF)

I Dustable powders (DP, DS)

Conventional seed treatment formulations include for example flowable concentrates FS, solutions LS, powders for dry treatment DS, water dispersible powders for slurry treatment WS, water-soluble powders SS and emulsion ES and EC and gel formulation GF. These formulations can be applied to the seed diluted or undiluted. Application to the seeds is carried out before sowing, either directly on the seeds or after having pregerminated the latter

In a preferred embodiment a FS formulation is used for seed treatment. Typcially, a FS formulation may comprise 1-800 g/l of active ingredient(s), 1-200 g/l surfactant, 0 to 200 g/l antifreezing agent, 0 to 400 g/l of binder, 0 to 200 g/l of a pigment and up to 1 liter of a solvent, preferably water.

Preferred FS formulations of compounds of formula I for seed treatment usually comprise from 0.1 to 80% by weight (1 to 800 g/l) of the active ingredient(s), from 0.1 to 20% by weight (1 to 200 g/l) of at least one surfactant, e.g. 0.05 to 5% by weight of a wetter and from 0.5 to 15% by weight of a dispersing agent, up to 20% by weight, e.g. from 5 to 20% of an anti-freeze agent, from 0 to 15% by weight, e.g. 1 to 15% by weight of a pigment and/or a dye, from 0 to 40% by weight, e.g. 1 to 40% by weight of a binder (sticker/adhesion agent), optionally up to 5% by weight, e.g. from 0.1 to 5% by weight of a thickener, optionally from 0.1 to 2% of an anti-foam agent, and optionally a preservative such as a biocide, antioxidant or the like, e.g. in an amount from 0.01 to 1% by weight and a filler/vehicle up to 100% by weight.

Seed Treatment formulations may additionally also comprise binders and optionally colorants.

Binders can be added to improve the adhesion of the active materials on the seeds after treatment. Suitable binders are block copolymers EO/PO surfactants but also polyvinylalcoholsl, polyvinylpyrrolidones, polyacrylates, polymethacrylates, polybutenes, polyisobutylenes, polystyrene, polyethyleneamines, polyethyleneamides, polyethyleneimines (Lupasol®, Polymin®), polyethers, polyurethans, polyvinylacetate, tylose and copolymers derived from these polymers.

Optionally, also colorants can be included in the formulation. Suitable colorants or dyes for seed treatment formulations are Rhodamin B, C.I. Pigment Red 112, C.I. Solvent Red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

The invention also relates to seed comprising mixtures according to the present invention. The amount of the compound I or the agriculturally useful salt thereof will in general vary from 0.1 g to 10 kg per 100 kg of seed, preferably from 1 g to 5 kg per 100 kg of seed, in particular from 1 g to 1000 g per 100 kg of seed.

Animal Health

The pesticidal mixtures of the present invention are in particular also suitable for being used for combating parasites in and on animals.

An object of the present invention is therfore also to provide new methods to control parasites in and on animals. Another object of the invention is to provide safer pesticides for animals. Another object of the invention is further to provide pesticides for animals that may be used in lower doses than existing pesticides. And another object of the invention is to provide pesticides for animals, which provide a long residual control of the parasites.

The invention also relates to compositions containing a pesticidally effective amount of compounds of formula I and spinetoram or the respective veterinarily acceptable isomers e.g. enantiomers or veterinarily acceptable salts thereof and an acceptable carrier, for combating parasites in and on animals.

The present invention also provides a method for treating, controlling, preventing and protecting animals against infestation and infection by parasites, which comprises orally, topically or parenterally administering or applying to the animals a parasiticidally effective amount of mixture of the present invention or a composition comprising it.

The present invention also provides a non-therapeutic method for treating, controlling, preventing and protecting animals against infestation and infection by parasites, which comprises applying to a locus a parasiticidally effective amount of a compound of formula I and spinetoram or the enantiomers or veterinarily acceptable salts thereof or a composition comprising them.

The invention also provides a process for the preparation of a composition for treating, controlling, preventing or protecting animals against infestation or infection by parasites which comprises including a parasiticidally effective amount of a compound of formula I or the enantiomers or veterinarily acceptable salts thereof and spinetoram in a composition comprising them.

The invention relates further to the use of compounds of formula I for treating, controlling, preventing or protecting animals against infestation or infection by parasites. The invention relates also to the use of a compound of formula I, or a composition comprising it, for the manufacture of a medicament for the therapeutic treatment of animals against infections or infestions by parasites.

Activity of compounds against agricultural pests does not suggest their suitability for control of endo- and ectoparasites in and on animals which requires, for example, low, non-emetic dosages in the case of oral application, metabolic compatibility with the animal, low toxicity, and a safe handling.

Surprisingly it has now been found that mixtures of the present invention are suitable for combating endo- and ectoparasites in and on animals.

The pesticidal mixtures of the present invention e.g. in form of compositions are preferably used for controlling and preventing infestations and infections animals including warm-blooded animals (including humans) and fish. They are for example suitable for controlling and preventing infestations and infections in mammals such as cattle, sheep, swine, camels, deer, horses, pigs, poultry, rabbits, goats, dogs and cats, water buffalo, donkeys, fallow deer and reindeer, and also in fur-bearing animals such as mink, chinchilla and raccoon, birds such as hens, geese, turkeys and ducks and fish such as fresh- and salt-water fish such as trout, carp and eels.

The pesticidal mixtures of the present invention e.g. in form of compositions are preferably used for controlling and preventing infestations and infections in domestic animals, such as dogs or cats.

Infestations in warm-blooded animals and fish include, but are not limited to, lice, biting lice, ticks, nasal bots, keds, biting flies, muscoid flies, flies, myiasitic fly larvae, chiggers, gnats, mosquitoes and fleas.

The pesticidal mixtures of the present invention e.g. in form of compositions are suitable for systemic and/or non-systemic control of ecto- and/or endoparasites. They are active against all or some stages of development.

The pesticidal mixtures of the present invention are especially useful for combating ectoparasites.

The pesticidal mixtures of the present invention are especially useful for combating parasites of the following orders and species, respectively:

fleas (Siphonaptera), e.g. Ctenocephandes fells, Ctenocephalides canis, Xenopsylla cheopis, Pulex irritans, Tunga penetrans, and Nosopsyllus fasciatus,

cockroaches (Blattaria—Blattodea), e.g. Blattella germanica, Blattella asahinae, Periplaneta americana, Periplaneta japonica, Periplaneta brunnea, Periplaneta fuligginosa, Periplaneta australasiae, and Blatta orientalis, flies, mosquitoes (Diptera), e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Chrysomya bezziana, Chrysomya hominivorax, Chrysomya macellaria, Chrysops discalis, Chrysops silacea, Chrysops atlanticus, Cochliomyia hominivorax, Cordylobia anthropophaga, Culicoides furens, Culex pipiens, Culex nigripalpus, Culex quinquefasciatus, Culex tarsalis, Culiseta inornata, Culiseta melanura, Dermatobia hominis, Fannia canicularis, Gasterophilus intestinalis, Glossina morsitans, Glossina palpalis, Glossina fuscipes, Glossina tachinoides, Haematobia irritans, Haplodiplosis equestris, Hippelates spp., Hypoderma lineata, Leptoconops torrens, Lucilia caprina, Lucilia cuprina, Lucilia sericata, Lycoria pectoralis, Mansonia spp., Musca domestica, Muscina stabulans, Oestrus ovis, Phlebotomus argentipes, Psorophora columbiae, Psorophora discolor, Prosimulium mixtum, Sarcophaga haemorrhoidalis, Sarcophaga sp., Simulium vittatum, Stomoxys calcitrans, Tabanus bovinus, Tabanus atratus, Tabanus lineola, and Tabanus similis,

lice (Phthiraptera), e.g. Pediculus humans capitis, Pediculus humanus corporis, Pthirus pubis, Haematopinus eurysternus, Haematopinus suis, Linognathus vituli, Bovicola bovis, Menopon gallinae, Menacanthus stramineus and Solenopotes capillatus.

ticks and parasitic mites (Parasitiformes): ticks (Ixodida), e.g. Ixodes scapularis, Ixodes holocyclus, Ixodes pacificus, Rhiphicephalus sanguineus, Dermacentor andersoni, Dermacentor variabilis, Amblyomma americanum, Ambryomma maculatum, Ornithodorus hermsi, Ornithodorus turicata and parasitic mites (Mesostigmata), e.g. Ornithonyssus bacoti and Dermanyssus gallinae,

Actinedida (Prostigmata) and Acaridida (Astigmata) e.g. Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp., and Laminosioptes spp,

Bugs (Heteropterida): Cimex lectularius, Cimex hemipterus, Reduvius sengis, Triatoma spp., Rhodnius ssp., Panstrongylus ssp. and Arilus critatus,

Anoplurida, e.g. Haematopinus spp., Linognathus spp., Pediculus spp., Phtirus spp., and Solenopotes spp,

Mallophagida (suborders Arnblycerina and Ischnocerina), e.g. Trimenopon spp., Menopon spp., Trinoton spp., Bovicola spp., Werneckiella spp., Lepikentron spp., Trichodectes spp., and Felicola spp,

Roundworms Nematoda:

Wipeworms and Trichinosis (Trichosyringida), e.g. Trichinellidae (Trichinella spp.), (Trichuridae) Trichuris spp., Capiliaria spp,

Rhabditida, e.g. Rhabditis spp, Strongyloides spp., Helicephalobus spp,

Strongylida, e.g. Strongylus spp., Ancylostoma spp., Necator americanus, Bunostomum spp. (Hookworm), Trichostrongylus spp., Haemonchus contortus., Ostertagia spp., Cooperia spp., Nematodirus spp., Dictyocaulus spp., Cyathostoma spp., Oesophagostomum spp., Stephanurus dentatus, Ollulanus spp., Chabertia spp., Stephanurus dentatus, Syngamus trachea, Ancylostoma spp., Uncinaria spp., Globocephalus spp., Necator spp., Metastrongylus spp., Muellerius capillaris, Protostrongylus spp., Angiostrongylus spp., Parelaphostrongylus spp. Aleurostrongylus abstrusus, and Dioctophyma renale,

Intestinal roundworms (Ascaridida), e.g. Ascaris lumbricoides, Ascaris suum, Ascaridia galli, Parascaris equorum, Enterobius vermicularis (Threadworm), Toxocara canis, Toxascaris leonine, Skrjabinema spp., and Oxyuris equi,

Camallanida, e.g. Dracunculus medinensis (guinea worm)

Spirurida, e.g. Thelazia spp. Wuchereria spp., Brugia spp., Onchocerca spp., Dirofilari spp.a, Dipetalonema spp., Setaria spp., Elaeophora spp., Spirocerca lupi, and Habronema spp.,

Thorny headed worms (Acanthocephala), e.g. Acanthocephalus spp., Macracanthorhynchus hirudinaceus and Oncicola spp,

Planarians (Plathelminthes):

Flukes (Trematoda), e.g. Faciola spp., Fascioloides magna, Paragonimus spp., Dicrocoelium spp., Fasciolopsis buski, Clonorchis sinensis, Schistosoma spp., Trichobilharzia spp., Alaria alata, Paragonimus spp., and Nanocyetes spp,

Cercomeromorpha, in particular Cestoda (Tapeworms), e.g. Diphyllobothrium spp., Tenia spp., Echinococcus spp., Dipylidium caninum, Multiceps spp., Hymenolepis spp., Mesocestoides spp., Vampirolepis spp., Moniezia spp., Anoplocephala spp., Sirometra spp., Anoplocephala spp., and Hymenolepis spp.

The pesticidal mixtures of the present invention e.g. in form of compositions are particularly useful for the control of pests from the orders Diptera, Siphonaptera and Ixodida.

Moreover, the use of pesticidal mixtures of the present invention e.g. in form of compositions for combating mosquitoes is especially preferred.

The use of the pesticidal mixtures of the present invention e.g. in form of compositions for combating flies is a further preferred embodiment of the present invention.

Furthermore, the use of the pesticidal mixtures of the present invention e.g. in form of compositions for combating fleas is especially preferred.

The use of the pesticidal mixtures of the present invention e.g. in form of compositions for combating ticks is a further preferred embodiment of the present invention.

The pesticidal mixtures of the present invention also are especially useful for combating endoparasites (roundworms nematoda, thorny headed worms and planarians).

The present invention relates to the therapeutic and the non-therapeutic use of the pesticidal mixture according to the present invention for controlling and/or combating parasites in and/or on animals.

The pesticidal mixtures according to the present invention may be used to protect the animals from attack or infestation by parasites by contacting them with a parasitically effective amount of the pesticidal mixture. As such, “contacting” includes both direct contact (applying the pesticidal mixtures/compositions directly on the parasite, which may include an indirect contact at it's locus-P, and optionally also administrating the pesticidal mixtures/composition directly on the animal) and indirect contact (applying the pesticidal mixture/compositions to the locus of the parasite). The contact of the parasite through application to its locus-P is an example of a non-therapeutic use of compounds of formula I.

“Locus-P” as defined in the above means the habitat, food supply, breeding ground, area, material or environment in which a parasite is growing or may grow outside of the animal.

The pesticidal mixtures of the invention can also be applied preventively to places at which occurrence of the pests or parasites is expected.

The administration to the animal can be carried out both prophylactically and therapeutically.

Administration of the pesticidal mixture is carried out directly or in the form of suitable preparations, orally, topically/dermally or parenterally.

For oral administration to warm-blooded animals, the pesticidal mixtures of the present invention may be formulated as animal feeds, animal feed premixes, animal feed concentrates, pills, solutions, pastes, suspensions, drenches, gels, tablets, boluses and capsules. In addition, the pesticidal mixtures of the present invention may be administered to the animals in their drinking water. For oral administration, the dosage form chosen should provide the animal with 0.01 mg/kg to 100 mg/kg of animal body weight per day of the formula I compound, preferably with 0.5 mg/kg to 100 mg/kg of animal body weight per day.

Alternatively, the pesticidal mixtures of the present invention may be administered to animals parenterally, for example, by intraruminal, intramuscular, intravenous or subcutaneous injection. The formula I compounds may be dispersed or dissolved in a physiologically acceptable carrier for subcutaneous injection. Alternatively, the mixtures of the present invention may be formulated into an implant for subcutaneous administration. In addition the formula I compound may be transdermally administered to animals. For parenteral administration, the dosage form chosen should provide the animal with 0.01 mg/kg to 100 mg/kg of animal body weight per day of the active compounds.

The pesticidal mixtures of the present invention may also be applied topically to the animals in the form of dips, dusts, powders, collars, medallions, sprays, shampoos, spot-on and pour-on formulations and in ointments or oil-in-water or water-in-oil emulsions. For topical application, dips and sprays usually contain 0.5 ppm to 5,000 ppm and preferably 1 ppm to 3,000 ppm of the active compounds. In addition, the active compound mixtures may be formulated as ear tags for animals, particularly quadrupeds such as cattle and sheep.

Suitable preparations are:
Solutions such as oral solutions, concentrates for oral administration after dilution, solutions for use on the skin or in body cavities, pouring-on formulations, gels;
Emulsions and suspensions for oral or dermal administration; semi-solid preparations;
Formulations in which the active compounds are processed in an ointment base or in an oil-in-water or water-in-oil emulsion base;
Solid preparations such as powders, premixes or concentrates, granules, pellets, tablets, boluses, capsules; aerosols and inhalants, and active compound-containing shaped articles.

Compositions suitable for injection are prepared by dissolving the active ingredient(s) in a suitable solvent and optionally adding further ingredients such as acids, bases, buffer salts, preservatives, and solubilizers. The solutions are filtered and filled sterile.

Suitable solvents are physiologically tolerable solvents such as water, alkanols such as ethanol, butanol, benzyl alcohol, glycerol, propylene glycol, polyethylene glycols, N-methyl-pyrrolidone, 2-pyrrolidone, and mixtures thereof.

The active compound(s) can optionally be dissolved in physiologically tolerable vegetable or synthetic oils which are suitable for injection.

Suitable solubilizers are solvents which promote the dissolution of the active compound(s) in the main solvent or prevent its precipitation. Examples are polyvinylpyrrolidone, polyvinyl alcohol, polyoxyethylated castor oil, and polyoxyethylated sorbitan ester.

Suitable preservatives are benzyl alcohol, trichlorobutanol, p-hydroxybenzoic acid esters, and n-butanol.

Oral solutions are administered directly. Concentrates are administered orally after prior dilution to the use concentration. Oral solutions and concentrates are prepared according to the state of the art and as described above for injection solutions, sterile procedures not being necessary.

Solutions for use on the skin are trickled on, spread on, rubbed in, sprinkled on or sprayed on.

Solutions for use on the skin are prepared according to the state of the art and according to what is described above for injection solutions, sterile procedures not being necessary.

Further suitable solvents are polypropylene glycol, phenyl ethanol, phenoxy ethanol, ester such as ethyl or butyl acetate, benzyl benzoate, ethers such as alkyleneglycol alkylether, e.g. dipropylenglycol monomethylether, ketons such as acetone, methylethylketone, aromatic hydrocarbons, vegetable and synthetic oils, dimethylformamide, dimethylacetamide, transcutol, solketal, propylencarbonate, and mixtures thereof.

It may be advantageous to add thickeners during preparation. Suitable thickeners are inorganic thickeners such as bentonites, colloidal silicic acid, aluminium monostearate, organic thickeners such as cellulose derivatives, polyvinyl alcohols and their copolymers, acrylates and methacrylates.

Gels are applied to or spread on the skin or introduced into body cavities. Gels are prepared by treating solutions which have been prepared as described in the case of the injection solutions with sufficient thickener that a clear material having an ointment-like consistency results. The thickeners employed are the thickeners given above.

Pour-on formulations are poured or sprayed onto limited areas of the skin, the active compound penetrating the skin and acting systemically.

Pour-on formulations are prepared by dissolving, suspending or emulsifying the active compound in suitable skin-compatible solvents or solvent mixtures. If appropriate, other auxiliaries such as colorants, bioabsorption-promoting substances, antioxidants, light stabilizers, adhesives are added.

Suitable solvents which are: water, alkanols, glycols, polyethylene glycols, polypropylene glycols, glycerol, aromatic alcohols such as benzyl alcohol, phenylethanol, phenoxyethanol, esters such as ethyl acetate, butyl acetate, benzyl benzoate, ethers such as alkylene glycol alkyl ethers such as dipropylene glycol monomethyl ether, diethylene glycol mono-butyl ether, ketones such as acetone, methyl ethyl ketone, cyclic carbonates such as propylene carbonate, ethylene carbonate, aromatic and/or aliphatic hydrocarbons, vegetable or synthetic oils, DMF, dimethylacetamide, n-alkylpyrrolidones such as methylpyrrolidone, n-butylpyrrolidone or n-octylpyrrolidone, N-methylpyrrolidone, 2-pyrrolidone, 2,2-dimethyl-4-oxy-methylene-1,3-diox-olane and glycerol formal.

Suitable colorants are all colorants permitted for use on animals and which can be dissolved or suspended.

Suitable absorption-promoting substances are, for example, DMSO, spreading oils such as isopropyl myristate, dipropylene glycol pelargonate, silicone oils and copolymers thereof with polyethers, fatty acid esters, triglycerides, fatty alcohols.

Suitable antioxidants are sulfites or metabisulfites such as potassium metabisulfite, ascorbic acid, butylhydroxytoluene, butylhydroxyanisole, tocopherol.

Suitable light stabilizers are, for example, novantisolic acid.

Suitable adhesives are, for example, cellulose derivatives, starch derivatives, polyacrylates, natural polymers such as alginates, gelatin.

Emulsions can be administered orally, dermally or as injections.

Emulsions are either of the water-in-oil type or of the oil-in-water type.

They are prepared by dissolving the active compound either in the hydrophobic or in the hydrophilic phase and homogenizing this with the solvent of the other phase with the aid of suitable emulsifiers and, if appropriate, other auxiliaries such as colorants, absorption-promoting substances, preservatives, antioxidants, light stabilizers, viscosity-enhancing substances.

Suitable hydrophobic phases (oils) are:

liquid paraffins, silicone oils, natural vegetable oils such as sesame oil, almond oil, castor oil, synthetic triglycerides such as caprylic/capric biglyceride, triglyceride mixture with vegetable fatty acids of the chain length C₈-C₁₂ or other specially selected natural fatty acids, partial glyceride mixtures of saturated or unsaturated fatty acids possibly also containing hydroxyl groups, mono- and diglycerides of the C₈-C₁₀ fatty acids, fatty acid esters such as ethyl stearate, di-n-butyryl adipate, hexyl laurate, dipropylene glycol perlargonate, esters of a branched fatty acid of medium chain length with saturated fatty alcohols of chain length C₁₆-C₁₈, isopropyl myristate, isopropyl palmitate, caprylic/capric acid esters of saturated fatty alcohols of chain length C₁₂-C₁₈, isopropyl stearate, oleyl oleate, decyl oleate, ethyl oleate, ethyl lactate, waxy fatty acid esters such as synthetic duck coccygeal gland fat, dibutyl phthalate, diisopropyl adipate, and ester mixtures related to the latter, fatty alcohols such as isotridecyl alcohol, 2-octyldodecanol, cetylstearyl alcohol, oleyl alcohol, and fatty acids such as oleic acid and mixtures thereof.

Suitable hydrophilic phases are: water, alcohols such as propylene glycol, glycerol, sorbitol and mixtures thereof.

Suitable emulsifiers are: non-ionic surfactants, e.g. polyethoxylated castor oil, polyethoxylated sorbitan monooleate, sorbitan monostearate, glycerol monostearate, polyoxyethyl stearate, alkylphenol polyglycol ether; ampholytic surfactants such as disodium N-lauryl-p-iminodipropionate or lecithin; anionic surfactants, such as sodium lauryl sulfate, fatty alcohol ether sulfates, mono/dialkyl polyglycol ether orthophosphoric acid ester monoethanolamine salt; cation-active surfactants, such as cetyltrimethylammonium chloride.

Suitable further auxiliaries are: substances which enhance the viscosity and stabilize the emulsion, such as carboxymethylcellulose, methylcellulose and other cellulose and starch derivatives, polyacrylates, alginates, gelatin, gum arabic, polyvinylpyrrolidone, polyvinyl alcohol, copolymers of methyl vinyl ether and maleic anhydride, polyethylene glycols, waxes, colloidal silicic acid or mixtures of the substances mentioned.

Suspensions can be administered orally or topically/dermally. They are prepared by suspending the active compound in a suspending agent, if appropriate with addition of other auxiliaries such as wetting agents, colorants, bioabsorption-promoting substances, preservatives, antioxidants, light stabilizers.

Liquid suspending agents are all homogeneous solvents and solvent mixtures.

Suitable wetting agents (dispersants) are the emulsifiers given above.

Other auxiliaries which may be mentioned are those given above.

Semi-solid preparations can be administered orally or topically/dermally. They differ from the suspensions and emulsions described above only by their higher viscosity.

For the production of solid preparations, the active compound is mixed with suitable excipients, if appropriate with addition of auxiliaries, and brought into the desired form.

Suitable excipients are all physiologically tolerable solid inert substances. Those used are inorganic and organic substances. Inorganic substances are, for example, sodium chloride, carbonates such as calcium carbonate, hydrogencarbonates, aluminium oxides, titanium oxide, silicic acids, argillaceous earths, precipitated or colloidal silica, or phosphates. Organic substances are, for example, sugar, cellulose, foodstuffs and feeds such as milk powder, animal meal, grain meals and shreds, starches.

Suitable auxiliaries are preservatives, antioxidants, and/or colorants which have been mentioned above.

Other suitable auxiliaries are lubricants and glidants such as magnesium stearate, stearic acid, talc, bentonites, disintegration-promoting substances such as starch or crosslinked polyvinylpyrrolidone, binders such as starch, gelatin or linear polyvinylpyrrolidone, and dry binders such as microcrystalline cellulose.

Generally it is favorable to apply the active compounds of the mixtures of the present invention in total amounts of 0.5 mg/kg to 100 mg/kg per day, preferably 1 mg/kg to 50 mg/kg per day.

Ready-to-use preparations typically contain the active ingredients of the pesticidally mixtures of the present invention acting against parasites, preferably ectoparasites, in concentrations of 10 ppm to 80 per cent by weight, preferably from 0.1 to 65 per cent by weight, more preferably from 1 to 50 per cent by weight, most preferably from 5 to 40 per cent by weight.

Preparations which are diluted before use contain the active ingredients of the mixtures of the present invention acting against ectoparasites in concentrations of 0.5 to 90 per cent by weight, preferably of 1 to 50 per cent by weight.

Furthermore, the preparations comprise the active compounds of the mixtures of the present invention against endoparasites in concentrations of 10 ppm to 2 per cent by weight, preferably of 0.05 to 0.9 per cent by weight, very particularly preferably of 0.005 to 0.25 per cent by weight.

In a preferred embodiment of the present invention, the pesticidal mixtures according to the invention, e.g. in form of compositions are applied dermally/topically or by fumigation.

In a further preferred embodiment, the topical application is conducted in the form of compound-containing shaped articles such as collars, medallions, ear tags, bands for fixing at body parts, and adhesive strips and foils.

Generally it is favorable to apply solid formulations which release the active ingredients of the mixtures of the present invention in total amounts of 10 mg/kg to 300 mg/kg, preferably 20 mg/kg to 200 mg/kg, most preferably 25 mg/kg to 160 mg/kg body weight of the treated animal in the course of three weeks.

For the preparation of the shaped articles, thermoplastic and flexible plastics as well as elastomers and thermoplastic elastomers may be used. Suitable plastics and elastomers are polyvinyl resins, polyurethane, polyacrylate, epoxy resins, cellulose, cellulose derivatives, polyamides and polyester which are sufficiently compatible with the compounds of formula I. A detailed list of plastics and elastomers as well as preparation procedures for the shaped articles is given e.g. in WO 03/086075.

Biological Efficacy

Synergism can be described as an interaction where the combined effect of two or more compounds is greater than the sum of the individual effects of each of the compounds. The presence of a synergistic effect in terms of percent control, between two or three mixing partners (A, B and C) can be calculated using the Colby equation (Colby, S. R., 1967, Calculating Synergistic and Antagonistic Responses in Herbicide Combinations, Weeds, 15, 20-22).

When the observed combined control effect is greater than the expected combined control effect (E), then the combined effect is synergistic.

The visually determined percentages of infected leaf areas are converted into efficacies in % of the untreated control:

The efficacy (E) is calculated as follows using Abbot's formula:

E=(1−α/β)·100

α corresponds to the pesticidal infection of the treated plants in % and

β corresponds to the pesticidal infection of the untreated (control) plants in %

An efficacy of 0 means that the infection level of the treated plants corresponds to that of the untreated control plants; an efficacy of 100 means that the treated plants are not infected.

Colby's formula:

E=x+y−x·y/100

or

E=x+y+z−(xy+xz+yz)/100+yxz/10000
E expected efficacy, expressed in % of the untreated control, when using the mixture of the active compounds A, B and optionally C at the respective concentrations a, b and optionally c
x efficacy, expressed in % of the untreated control, when using the active compound A at the concentration a
y efficacy, expressed in % of the untreated control, when using the active compound B at the concentration b
z efficacy, expressed in % of the untreated control, when using the active compound C at the concentration c

The following tests demonstrate the control efficacy of compounds, mixtures or compositions of this invention on specific pests. However, the pest control protection afforded by the compounds mixtures or compositions is not limited to these species. In certain instances, combinations of a compound of this invention with other invertebrate pest control compounds or agents are found to exhibit synergistic effects against certain important invertebrate pests.

Fungicidal Action

The pesticidal effect of the mixtures according to the invention can be demonstrated by the following examples, without being limited to these.

Microtest

The active compounds were formulated separately as a stock solution having a concentration of 10000 ppm in dimethyl sulfoxide.

The products pyraclostrobin and epoxiconazole were used as commercial finished formulations and diluted with water to the stated concentration of the active compound.

1. Activity Against the Late Blight Pathogen Phytophthora infestans in the Microtiter Test (Phytin)

The stock solutions were mixed according to the ratio, pipetted onto a micro titer plate (MTP) and diluted with water to the stated concentrations. A spore suspension of Phytophtora infestans containing a pea juice-based aqueous nutrient medium was then added. The plates were placed in a water vapor-saturated chamber at a temperature of 18° C. Using an absorption photometer, the MTPs were measured at 405 nm 7 days after the inoculation.

2. Activity Against the Grey Mold Botrytis cinerea in the Microtiterplate Test (Botrci)

The stock solutions were mixed according to the ratio, pipetted onto a micro titer plate (MTP) and diluted with water to the stated concentrations. A spore suspension of Botrci cinerea in an aqueous biomalt solution was then added. The plates were placed in a water vapor-saturated chamber at a temperature of 18° C. Using an absorption photometer, the MTPs were measured at 405 nm 7 days after the inoculation.T

3. Activity Against Rice Blast Pyricularia oryzae in the Microtiterplate Test (Pyrior)

The stock solutions were mixed according to the ratio, pipetted onto a micro titer plate (MTP) and diluted with water to the stated concentrations. A spore suspension of Pyricularia oryzae in an aqueous biomalt solution was then added. The plates were placed in a water vapor-saturated chamber at a temperature of 18° C. Using an absorption photometer, the MTPs were measured at 405 nm 7 days after the inoculation.

4. Activity Against Leaf Blotch on Wheat Caused by Septoria tritici (Septtr)

The stock solutions were mixed according to the ratio, pipetted onto a micro titer plate (MTP) and diluted with water to the stated concentrations. A spore suspension of Septoria tritici in an aqueous biomalt solution was then added. The plates were placed in a water vapor-saturated chamber at a temperature of 18° C. Using an absorption photometer, the MTPs were measured at 405 nm 7 days after the inoculation.

The measured parameters were compared to the growth of the active compound-free control variant (100%) and the fungus-free and active compound-free blank value to determine the relative growth in % of the pathogens in the respective active compounds. These percentages were converted into efficacies.

The results of the different tests are as follows summarized:

Botrci

| Active | Concen- | | | Calculated | Syner- |
|---|---|---|---|---|---|
| compound/ | tration | | Observed | efficacy | gism |
| mixture | (ppm) | Mixture | efficacy | (Colby) | (%) |
| Spinetoram | 63 | — | 21 | | |
| | 16 | — | 0 | | |
| | 4 | — | 1 | | |
| | 0.25 | — | 1 | | |
| Sulfoximin | 16 | — | 2 | | |
| | 4 | — | 5 | | |
| | 0.25 | — | 4 | | |
| sedaxane | 0.25 | — | 41 | | |
| penthiopyrad | 0.063 | — | 32 | | |
| penthiopyrad | 0.25 | — | 45 | | |
| Prothioconazol | 0.063 | — | 19 | | |
| Epoxiconazol | 0.25 | — | 25 | | |
| Mancozeb | 16 | — | 46 | | |
| Pyraclostrobin | 0.25 | — | 4 | | |
| Spinetoram + | 16 + 16 | 63:63:1 | 62 | 44 | 18 |
| Sulfoximin | 0.25 | | | | |
| sedaxane | | | | | |
| Spinetoram + | 4 + 4 | 63:63:1 | 54 | 36 | 18 |
| Sulfoximin | 0.063 | | | | |
| penthiopyrad | | | | | |
| Spinetoram + | 16 + 16 | 63:63:1 | 71 | 48 | 23 |
| Sulfoximin | 0.25 | | | | |
| penthiopyrad | | | | | |
| Spinetoram + | 0.25 + 0.25 | 4:4:1 | 41 | 23 | 18 |
| Sulfoximin | 0.063 | | | | |
| Prothioconazol | | | | | |
| Spinetoram + | 16 + 16 | 63:63:1 | 71 | 29 | 42 |
| Sulfoximin | 0.25 | | | | |
| Epoxiconazol | | | | | |
| Spinetoram + | 63 + 63 | 4:4:1 | 100 | 57 | 43 |
| Sulfoximin | 16 | | | | |
| Mancozeb | | | | | |
| Spinetoram + | 63 + 16 | 250:63:1 | 51 | 31 | 20 |
| Sulfoximin | 0.25 | | | | |
| Pyraclostrobin | | | | | |

Pyrior

| active | Concen- | | | Calculated | Syner- |
|---|---|---|---|---|---|
| compound/ | tration | | Observed | efficacy | gism |
| mixture | (ppm) | Mixture | efficacy | (Colby) | (%) |
| Spinetoram | 63 | — | 34 | | |
| | 16 | — | 2 | | |
| | 4 | — | 2 | | |
| Sulfoximin | 63 | — | 8 | | |
| | 4 | — | 1 | | |
| penthiopyrad | 1 | — | 55 | | |
| Carbendazim | 0.25 | — | 15 | | |
| penthiopyrad | 0.25 | — | 6 | | |
| Spiretoram + | 63 + 63 | 63:63:1 | 96 | 69 | 27 |
| Sulfoximin | 1 | | | | |
| penthiopyrad | | | | | |
| Spiretoram + | 4 + 4 | 16:16:1 | 43 | 19 | 24 |
| Sulfoximin | 0.25 | | | | |
| Carbendazim | | | | | |
| Spiretoram + | 16 + 4 | 63:16:1 | 98 | 9 | 89 |
| Sulfoximin | 0.25 | | | | |
| penthiopyrad | | | | | |

Septtr

| active | Concen- | | | | Syn- |
|---|---|---|---|---|---|
| compound/ | tration | | Observed | Calculated | ergism |
| mixture | (ppm) | Mixture | efficacy | (Colby) | (%) |
| Spinetoram | 63 | — | 4 | | |
| 0 | 16 | — | 0 | | |
| | 4 | — | | | |
| Sulfoximin | 63 | — | 5 | | |
| | 4 | — | 8 | | |
| Azoxystrobin | 0.063 | — | 56 | | |
| Fenhexamid | 16 | — | 33 | | |
| Propineb | 1 | — | 25 | | |
| Spiretoram + | 4 + 4 | 63:63:1 | 84 | 61 | 23 |
| Sulfoximin | 0.063 | | | | |
| Azoxystrobin | | | | | |
| Spiretoram + | 63 + 63 | 4:4:1 | 82 | 45 | 37 |
| Sulfoximin | 16 | | | | |
| Fenhexamid | | | | | |
| Spiretoram + | 16 + 4 | 16:4:1 | 52 | 25 | 27 |
| Sulfoximin | 1 | | | | |
| Propineb | | | | | |

Phytin

| active | Concen- | | | Calculated | Syner- |
|---|---|---|---|---|---|
| compound | tration | | Observed | efficacy | gism |
| mixture | (ppm) | Mixture | efficacy | (Colby) | (%) |
| Spinetoram | 16 | — | 24 | | |
| | 4 | — | 2 | | |
| Sulfoximin | 16 | — | 18 | | |
| | 4 | — | 6 | | |
| Propineb | 1 | — | 23 | | |
| Cyazofamid | 0.063 | — | 67 | | |
| Spiretoram + | 16 + 16 | 16:16:1 | 97 | 41 | 56 |
| Sulfoximin | 1 | | | | |
| Propineb | | | | | |
| Spiretoram + | 4 + 4 | 16:16:1 | 95 | 68 | 27 |
| Sulfoximin | 0.063 | | | | |
| Cyazofamid | | | | | |

1. A pesticidal mixture comprising
1) at least one active cyanosulfoximine compound I of formula I: 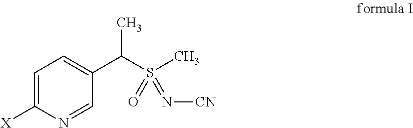
wherein
X is Cl or CF₃
or an enantiomer or a diastereomer thereof, pure or as mixtures of these enantiomers
and/or diastereomers
and/or salts thereof
and
2) spinetoram
in synergistically effective amounts.

2. mixture of claim 1, wherein the mixture comprises as additional active compound at least one other insecticide or fungicide.

3. The mixture according to claim 1, wherein the mixture additionally comprises
at least one active compound III selected from the groups III.A to III.F:
III.A an azole selected from the group consisting of triazoles, imidazoles, pyrazoles, thiazoles and oxazoles selected from the group consisting of azaconazole, benomyl, bitertanol, bromuconazole, carbendazim, cyproconazole, cyazofamid, difenoconazole, diniconazole, diniconazole-M, enilconazole, epoxiconazole, ethaboxam, etridiazole, fluquinconazole, fenbuconazole, flusilazole, flutriafol, fuberidazole, hexaconazole, hymexazole, imazalil, imazalil-sulfphate, imibenconazole, ipconazole, metconazole, myclobutanil, oxpoconazol, paclobutrazol, pefurazoate, penconazole, prochloraz, propiconazole, prothioconazole, simeconazole, triadimefon, triadimenol, tebuconazole, tetraconazole, thiabendazole, triticonazole, triflumizole, uniconazol, and 1-(4-chloro-phenyl)-2-([1,2,4]triazol-1-yl)-cycloheptanol;
III.B a strobilurin selected from the group consisting of azoxystrobin, dimoxystrobin, enestroburin, fluoxastrobin, kresoxim-methyl, methominostrobin, orysastrobin, picoxystrobin, pyraclostrobin, pyribencarb, trifloxystrobin, methyl 2-(ortho-(2,5-dimethylphenyloxymethylene)phenyl)-3-methoxy-acrylate, 2-(2-(6-(3-chloro-2-methyl-phenoxy)-5-fluoro-pyrimidin-4-yloxy)-phenyl)-2-methoxyimino-N-methyl-acetamide and 3-methoxy-2-(2-(N-(4-methoxy-phenyl)-cyclo-propanecarboximidoylsulfanylmethyl)-phenyl)-acrylic acid methyl ester;
III.C a carboxamide selected from the group consisting of benalaxyl, benalaxyl-M, benodanil, bixafen, boscalid, carboxin, carpropamid, dimethomorph, diclocymet, fenhexamid, fluopyram, flutolanil, furametpyr, flumorph, flumetover, fluopicolide (picobenzamid), mandipropamid, mepronil, metalaxyl, mefenoxam, ofurace, oxadixyl, oxycarboxin, oxytetracyclin, penthiopyrad, silthiofam,thifluzamide, tiadinil, zoxamide, 5-fluoro-1,3-dimethyl-1H-pyrazole-4-carboxylic acid [2-(1,2-dimethyl-propyl)-phenyl]-amide, methyl-3-(4-chlorophenyl)-3-(2-isopropoxycarbonylamino-3-methylbutyrylamino)propionate, 2-chloro-N-(1,1,3-trimethyl-indan-4-yl)-nicotinamide, N-(3-ethyl-3,5-5-trimethyl-cyclohexyl)-3-formylamino-2-hydroxy-benzamide, N-(2-{4-[3-(4-chlorophenyl)prop-2-ynyloxy]-3-methoxyphenyl}ethyl)-2-methanesulfonylamino-3-methylbutyramide, N-(2-{4-[3-(4-chlorophenyl)-prop-2-ynyloxy]-3-methoxyphenyl}ethyl)-2-ethanesulfonylamino-3-methyl-butyramide, N-(6-methoxy-pyridin-3-yl)cyclopropane-carboxamide, 2-amino-4-methyl-thiazole-5-carboxamide, N-(2-cyanophenyl)-3,4-dichloroisothiazole-5-carboxamide, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide, N-(3′,4′-dichloro-5-fluorobiphenyl-2-yl)-3-difluoromethyl-1-methylpyrazole-4-carboxamide; N-(3′,4′-dichloro-4-fluorobiphenyl-2-yl)-3-difluoromethyl-1-methylpyrazole-4-carboxamide, N-(3′,4′-dichloro-5-fluorobiphenyl-2-yl)-3-difluoromethyl-1-methylpyrazole-4-carboxamide, N-(2-(1,3-dimethylbutyl)-phenyl)-1,3-dimethyl-5-fluoro-1H-pyrazole-4-carboxamide, N-(4′-chloro-3′,5-difluoro-biphenyl-2-yl)-3-difluoromethyl-1-methyl-1H-pyrazole-4-carbox amide, N-(4′-chloro-3′,5-difluoro-biphenyl-2-yl)-3-trifluoromethyl-1-methyl-1H-pyrazole-4-carbox amide, N-(3′,4′-dichloro-5-fluoro-biphenyl-2-yl)-3-trifluoromethyl-1-methyl-1H-pyrazole-4-carbox amide, N-(3′,5-difluoro-4′-methyl-biphenyl-2-yl)-3-difluoromethyl-1-methyl-1H pyrazole-4-carboxamide,N-(3′,5-difluoro-4′-methyl-biphenyl-2-yl)-3-trifluoromethyl-1-methyl-1H-pyrazole-4-carboxamide, N-(cis-2-bicyclopropyl-2-yl-phenyl)-3-difluoromethyl-1-methyl-1H-pyrazole-4-carboxamide, N-(trans-2-bicyclopropyl-2-yl-phenyl)-3-difluoromethyl-1-methyl-1H-pyrazole-4-carboxamide, N-(2′,4′-difluorobiphenyl-2-yl)-1-methyl-3-trifluoromethyl-1H-pyrazole-4-carboxamide, N-(2′,4′-dichlorobiphenyl-2-yl)-1-methyl-3-trifluoromethyl-1H-pyrazole-4-carboxamide, N-(2′,4′-difluorobiphenyl-2-yl)-3-difluoromethyl-1-methyl-1H-pyrazole-4-carboxamide, N-(2′,4′-dichlorobiphenyl-2-yl)-3-difluoromethyl-1-methyl-1H-pyrazole-4-carboxamide, N-(2′,5′-difluorobiphenyl-2-yl)-1-methyl-3-trifluoromethyl-1H-pyrazole-4-carboxamide, N-(2′,5′-dichlorobiphenyl-2-yl)-1-methyl-3-trifluoromethyl-1H-pyrazole-4-carboxamide, N-(2′,5′-difluorobiphenyl-2-yl)-3-difluoromethyl-1-methyl-1H-pyrazole-4-carboxamide, N-(2′,5′-dichlorobiphenyl-2-yl)-3-difluoromethyl-1-methyl-1H-pyrazole-4-carboxamide, N-(3′,5′-difluorobiphenyl-2-yl)-1-methyl-3-trifluoromethyl-1H-pyrazole-4-carboxamide, N-(3′,5′-dichlorobiphenyl-2-yl)-1-methyl-3-trifluoromethyl-1H-pyrazole-4-carboxamide, N-(3′,5′-difluorobiphenyl-2-yl)-3-difluoromethyl-1-methyl-1H-pyrazole-4-carboxamide, N-(3′,5′-dichlorobiphenyl-2-yl)-3-difluoromethyl-1-methyl-1H-pyrazole-4-carboxamide, N-(3′-fluorobiphenyl-2-yl)-1-methyl-3-trifluoromethyl-1H-pyrazole-4-carboxamide, N-(3′-chlorobiphenyl-2-yl)-1-methyl-3-trifluoromethyl-1H-pyrazole-4-carboxamide; N-(3′-fluorobiphenyl-2-yl)-3-difluoromethyl-1-methyl-1H-pyrazole-4-carboxamide, N-(3′-chlorobiphenyl-2-yl)-3-difluoromethyl-1-methyl-1H-pyrazole-4-carboxamide, N-(2′-fluorobiphenyl-2-yl)-1-methyl-3-trifluoromethyl-1H-pyrazole-4-carboxamide, N-(2′-chlorobiphenyl-2-yl)-1-methyl-3-trifluoromethyl-1H-pyrazole-4-carboxamide, N-(2′-fluorobiphenyl-2-yl)-3-difluoromethyl-1-methyl-1H-pyrazole-4-carboxamide, N-(2′-chlorbiphenyl-2-yl)-3-difluoromethyl-1-methyl-1H-pyrazole-4-carboxamide; N-(2′-fluoro-4′-chloro-5′-methylbiphenyl-2-yl)-1-methyl-3-trifluoromethyl-1H-pyrazole-4-carboxamide, N-(3′,4′,5′-trifluorobiphenyl-2-yl)-1-methyl-3-trifluoromethyl-1H-pyrazole-4-carboxamide, N-(3′,4′,5′-trifluorobiphenyl-2-yl)-1-methyl-3-difluoromethyl-1H-pyrazole-4-carboxamide, N-(2′,4′,5′-trifluorobiphenyl-2-yl)-1-methyl-3-difluoromethyl-1H-pyrazole-4-carboxamide, N-(3′,4′,5′-trifluorobiphenyl-2-yl)-3-chlorofluoromethyl-1-methyl-1H-pyrazole-4-carboxamide, N-[2-(1,1,2,3,3,3-hexafluoropropoxy)phenyl]-1-methyl-3-trifluoromethyl-1H-pyrazole-4-carboxamide, N-[2-(1,1,2,3,3,3-hexafluoropropoxy)-phenyl]-3-difluoromethyl-1-methyl-1H-pyrazole-4-carboxamide, N-[2-(2-chloro-1,1,2-trifluoroethoxy)phenyl]-1-methyl-3-trifluoromethyl-1H-pyrazole-4-carboxamide, N-[2-(2-chlor-1,1,2-trifluoroethoxy)phenyl]-3-difluoromethyl-1-methyl-1H-pyrazole-4-carboxamide, N-[2-(1,1,2,2-tetrafluoroethoxy)phenyl]-3-difluoromethyl-1-methyl-1H-pyrazole-4-carboxamide, N-[2-(1,1,2,2-tetrafluoroethoxy)phenyl]-1-methyl-3-trifluoromethyl-1H-pyrazole-4-carboxamide, N-(4′-(trifluoromethylthio)biphenyl-2-yl)-3-difluoromethyl-1-methyl-1H pyrazole-4-carboxamide, and N-(4′-(trifluoromethylthio)biphenyl-2-yl)-1-methyl-3-trifluoromethyl-1H-pyrazole-4-carboxamide;
III.D heterocyclic compound selected from the group consisting of acibenzolar-S-methyl, anilazine, aldimorph, blasticidin-S, bupirimate, captafol, captan, chinomethionat, cyprodinil, dazomet, debacarb, diclomezine, difenzoquat, difenzoquat-methylsulphat, diflumetorim, dodemorph, dodemorph-acetate, famoxadone, fenamidone, fenarimol, ferimzone, fenpiclonil, fenpropidin, fenpropimorph, fludioxonil, fluazinam, fluoroimid, folpet, fenoxanil, iprodione, mepanipyrim, nitrapyrin, nuarimol, octhilinone, oxolinic acid, piperalin, probenazole, procymidone, proquinazid, pyrifenox, pyrimethanil, pyroquilon, quinoxyfen, tricyclazole, triforine, tridemorph, vinclozolin, 5-chloro-7-(4-methylpiperidin-1-yl)-6-(2,4,6-trifluorophenyl)-[1,2,4]triazolo[1,5-a]pyrimidine, 6-(4-tert-butylphenyl)-5-methyl-[1,2,4]triazolo[1,5-a]pyrimidine-7-ylamine, 5-methyl-6-(3,5,5-trimethyl-hexyl)-[1,2,4]triazolo[1,5-a]pyrimidine-7-ylamine, 5-methyl-6-octyl-[1,2,4]triazolo[1,5-a]pyrimidine-7-yl-amine, 6-methyl-5-octyl-[1,2,4]tri-azolo[1,5-a]pyrimidine-7-yl-amine, 6-ethyl-5-octyl-[1,2,4]triazolo[1,5-a]pyrimidine-7-yl-amine, 5-ethyl-6-octyl-[1,2,4]triazolo[1,5-a]pyri-midine-7-ylamine, 5-ethyl-6-(3,5,5-trimethyl-hexyl)-[1,2,4]tri-azo-lo[1,5-a]pyrimi-dine-7-ylamine, 6-octyl-5-propyl-[1,2,4]triazolo[1,5-a]pyrimidine-7-yl-amine, 5-methoxy-methyl-6-octyl-[1,2,4]triazolo[1,5-a]pyrimidine-7-yl-amine, 6-octyl-5-trifluoromethyl-[1,2,4]triazolo[1,5-a]pyrimidine-7-yl-amine and 5-trifluoromethyl-6-(3,5,5-trimethyl-hexyl)-[1,2,4]tri-azolo[1,5-a]pyrimidine-7-ylamine, 2,3,5,6-tetrachloro-4-methanesulfonyl-pyridine, 3,4,5-trichloro-pyridine-2,6-di-carbonitrile, N-(1-(5-bromo-3-chloro-pyridin-2-yl)-ethyl)-2,4-dichloro-nicotinamide, N-((5-bromo-3-chloro-pyridin-2-yl)-methyl)-2,4-dichloro-nicotinamide, 2-butoxy-6-iodo-3-propylchromen-4-one and N,N-dimethyl-3-(3-bromo-6-fluoro-2-methylindole-1-sulfonyl)-[1,2,4]triazole-1-sulfonamide;
III.E a carbamate selected from the group consisting of diethofencarb, ferbam, flubenthiavalicarb, iprovalicarb, mancozeb, maneb, metam, methasulphocarb, metiram, propamocarb, propamocarb hydrochlorid,propineb, thiram, zineb, ziram, 4-fluorophenyl N-(1-(1-(4-cyanophenyl)ethanesulfonyl)but-2-yl)carbamate, methyl 3-(4-chlorophenyl)-3-(2-isopropoxycarbonylamino-3-methyl-butyrylamino)propanoate and carbamate oxime ethers of the formula III^{E.1} 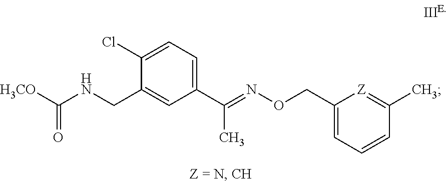
III.F a fungicide selected from
the group of antibiotics comprising kasugamycin, kasugamycin-hydrochlorid-hydrat, mildiomycin, streptomycin, polyoxin and validamycin A;
the group of nitrophenyl derivatives comprising binapacryl, dinocap, dinobuton, dicloran, nitrothal-isopropyl and tecnazen;
the group of sulfur-containing heterocyclyl compounds comprising dithianon and isoprothiolane;
the group of organometallic compounds comprising fentin salts;
the group of organophosphorus compounds comprising edifenphos, iprobenfos, fosetyl, fosetyl-aluminum, phosphorous acid and its salts, pyrazophos and tolclofos-methyl;
the group of organochlorine compounds comprising chlorothalonil, dichlofluanid, dichlorophen, pentachlorophenol and its salts, flusulfamide, hexachlorobenzene, phthalide, pencycuron, quintozene, thiophanate-methyl and tolylfluanid;
the group of inorganic active compounds comprising Bordeaux mixture, copper acetate, copper hydroxide, copper oxychloride, basic copper sulfate, oxin-copper and sulfur;
and/or selected from a group of various fungicides consisting of biphenyl, bronopol, cyflufenamid, cymoxanil, diphenylamine, dimethirimol, dodine, dodine free base, ethirimol, furalaxyl, iminoctadine, iminoctadine-triacetate, iminoctadine-tris(albesilate), guazatine, guazatine-acetate, metrafenone, prohexadione calcium, spiroxamine guanidine, N-(4-chloro-2-nitro-phenyl)-N-ethyl-4-methyl-benzenesulfonamide, N-(cyclopropylmethoxyimino-(6-difluoromethoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluormethyl-4-(3-trimethylsilanyl-propoxy)-phenyl)-N-ethyl-N-methyl formamidine and N′-(5-difluormethyl-2-methyl-4-(3-trimethylsilanyl-propoxy)-phenyl)-N-ethyl-N-methyl formamidine;
or an enantiomer or a diastereomer thereof, pure or as mixtures of these enantiomers and/or diastereomers and/or salts thereof.

4. The pesticidal mixture of claim 1, wherein the mixture additionally comprises at least one active compound II selected from group II.A.1 to II.A.13 consisting of
II.A.1 an Acetylcholine esterase inhibitor selected from triazemate or from the class of carbamates consisting of aldicarb, alanycarb, benfuracarb, carbaryl, carbofuran, carbosulfan, methiocarb, methomyl, oxamyl, primicarb, propoxur and thiodicarb, or from the class of organophosphates consisting of acephate, azinphos-ethyl, azinphos-methyl, chlorfenvinphos, chlorpyrifos, chlorpyrifos-methyl, demeton-S-methyl, diazinon, dichlorvos/DDVP, dicrotophos, dimethoate, disulfoton, ethion, fenitrothion, fenthion, isoxathion, malathion, methamidaphos, methidathion, mevinphos, monocrotophos, oxymethoate, oxydemeton-methyl, parathion, parathion-methyl, phenthoate, phorate, phosalone, phosmet, phosphamidon, pirimiphos-methyl, quinalphos, terbufos, tetrachlorvinphos, triazophos and trichlorfon;
II.A.2 a GABA-gated chloride channel antagonist selected from the group consisting of cyclodiene organochlorine endosulfan, N-Ethyl-2,2-dimethylpropionamide-2-(2,6-dichloro-α.α.α-trifluoro-p-tolyl) hydrazon, N-Ethyl-2,2-dichloro-1-methylcyclopropane-carboxamide-2-(2,6-dichloro-α.α.α-trifluoro-p-tolyl) hydrazon or from the class of phenylpyrazoles consisting of acetoprole, ethiprole, fipronil, pyrafluprole, pyriprole, vaniliprole and the phenylpyrazole compound II.A^{2.1}: 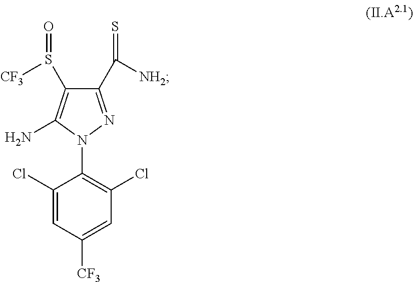
II.A.3 a Sodium channel modulator selected from the class of pyrethroids consisting of allethrin, bifenthrin, cyfluthrin, lambda-cyhalothrin, cypermethrin, alpha-cypermethrin, beta-cypermethrin, zeta-cypermethrin, deltamethrin, esfenvalerate, etofenprox, fenpropathrin, fenvalerate, flucythrinate, tau-fluvalinate, permethrin, silafluofen and tralomethrin;
II.A.4 a Nicotinic acetylcholine receptor agonist/antagonist selected from the group consisting of nicotin, cartap hydrochloride, and thiocyclam or from the class of neonicotinoids consisting of acetamiprid, chlothianidin, dinotefuran, imidacloprid, nitenpyram, thiacloprid, thiamethoxam and AKD-1022; or the allosteric nicotinic acteylcholine receptor agonist spinosad;
II.A.5 a Chloride channel activator selected from the group consisting of abamectin, emamectin benzoate, lepimectin and milbemectin;
II.A.6 a Juvenile hormone mimic selected from the group consisting of hydroprene, kinoprene, fenoxycarb and pyriproxyfen;
II.A.7 a compound affecting the oxidative phosphorylation selected from the group consisting of diafenthiuron, fenbutatin oxide, propargite and chlorfenapyr;
II.A.8 an inhibitor of the chitin biosynthesis selected from buprofezin or from the class of benzylureas consisting of bistrifluron, diflubenzuron, flufenoxuron, hexaflumuron, lufenuron, novaluron and teflubenzuron;
II.A.9 a Moulting disruptor selected from cyromazine or from the class of ecdysone agonists consisting of methoxyfenozide, tebufenozide and azadirachtin;
II.A.10 a Mitochondrial electron transport inhibitor selected from the group consisting of pyridaben, tolfenpyrad and flufenerim.
II.A.11 a Voltage-dependent sodium channel blocker selected from the group consisting of indoxacarb and metaflumizone.
II.A.12 an inhibitor of the lipid synthesis selected from the group consisting of spirodiclofen, spiromesifen and spirotetramat.
II.A.13 a compound selected from the group consisting of amidoflumet, amitraz, bifenazate, clofentezine, cyenopyrafen, cyflumetofen, etoxazole, flonicamid, flubendiamine, flupyrazophos, hexythiazox, piperonyl butoxide, pymetrozine, pyridalyl, pyrifluquinazon, chlorantraniliprole, the anthranilamid compound II.A^{13.1}: 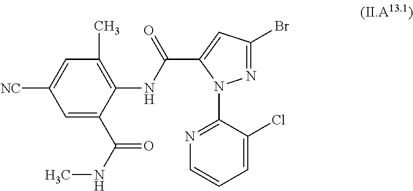
and the phenylsulfonamide compounds 2-Cyano-N-ethyl-4-fluoro-3-methoxy-benzenesulfonamide, 2-Cyano-N-ethyl-3-methoxy-benzenesulfonamide, 2-Cyano-3-difluoromethoxy-N-ethyl-4-fluoro-benzenesulfonamide, 2-Cyano-3-difluoromethoxy-N-ethyl-benzenesulfonamide, 2-Cyano-6-fluoro-3-methoxy-N,N-dimethyl-benzenesulfonamide, 2-Cyano-3-methoxy-N,N-dimethyl-benzenesulfonamide, 2-Cyano-N-ethyl-6-fluoro-3-methoxy-N-methyl-benzenesulfonamide and 2-Cyano-3-difluoromethoxy-N,N-dimethyl-benzenesulfonamide
or an enantiomer or a diastereomer thereof, pure or as mixtures of these enantiomers and/or diastereomers and/or salts thereof.

5. The pesticidal mixture according to claim 1, wherein at least one active compound III is selected within the group III.A of azoles consisting of benomyl, carbendazim, epoxiconazole, fluquinconazole, flutriafol, flusilazole, metconazole, prochloraz, prothioconazole, tebuconazole and triticonazole.

6. The pesticidal mixture according to claim 1, comprising at least an active compound III which is the strobilurin pyraclostrobin.

7. The pesticidal mixture according to claim 1, wherein at least one active compound III is selected within the group III.C of carboxamides consisting of boscalid, dimethomorph or penthiopyrad.

8. The pesticidal mixture according to claim 1, wherein at least one active compound III is selected within the group III.D of heterocyclic compounds consisting of dodemorph, famoxadone, fenpropimorph, proquinazid pyrimethanil, tridemorph or 5-chloro-7-(4-methylpiperidin-1-yl)-6-(2,4,6-trifluorophenyl)-[1,2,4]triazolo[1,5-a]pyrimidine.

9. The pesticidal mixture according to claim 1, wherein at least one active compound III is selected within the group III.E of carbamates consisting of maneb, mancozeb, metiram and thiram.

10. The pesticidal mixture according to claim 1, wherein at least one active compound III is selected within the group III.F of other fungicides consisting of chlorothalonil, dithianon, flusulfamide, metrafenone and phosphorous acid and/or its salts.

11. The pesticidal mixture according to claim 1, wherein at least one active compound II selected within group II.A.2 is N-Ethyl-2,2-dimethylpropionamide-2-(2,6-dichloro-α.α.α-trifluoro-p-tolyl) hydrazon, N-Ethyl-2,2-dichloro-1-methylcyclopropane-carboxamide-2-(2,6-dichloro-α.α.α-trifluoro-p-tolyl) hydrazon, acetoprole or fipronil.

12. The pesticidal mixture according to claim 1, wherein at least one active compound II selected within group II.A.3 is alpha-cypermethrin or deltamethrin.

13. The pesticidal mixture according to claim 1, wherein at least one active compound II selected within group II.A.4 is clothianidin, imidacloprid or thiamethoxam.

14. The pesticidal mixture according to claim 1, comprising at least an active compound II which is the abamectin.

15. The pesticidal mixture according to claim 1, comprising at least an active compound II which is the diafenthiuron.

16. The pesticidal mixture according to claim 1, comprising at least an active compound II which is the buprofezin.

17. The pesticidal mixture according to claim 1, wherein at least one active compound II selected within group II.A.10 is pyridaben or flufenerim.

18. The pesticidal mixture according to claim 1, comprising at least an active compound II which is metaflumizone.

19. The pesticidal mixture according to claim 1, wherein at least one active compound II selected within group II.A.12 is spiromesifen or spirotetramat.

20. The pesticidal mixture according to claim 1, comprising at least an active compound II which is flonicamid.

21. The pesticidal mixture according to claim 1, wherein at least one active compound II selected within group II.A.13 is pymetrozine or pyrifluquinazon.

22. The pesticidal mixture according to claim 1, wherein at least one active compound II selected within group II.A.13 is chlorantraniliprole or the anthranil compound II.A^{13.1}.

23. The pesticidal mixture according to claim 1, wherein at least one active compound II selected within group II.A.13 is 2-Cyano-N-ethyl-4-fluoro-3-methoxy-benzenesulfonamide, 2-Cyano-N-ethyl-3-methoxy-benzenesulfonamide, 2-Cyano-3-difluoromethoxy-N-ethyl-4-fluoro-benzenesulfonamide, 2-Cyano-3-difluoromethoxy-N-ethyl-benzenesulfonamide, 2-Cyano-6-fluoro-3-methoxy-N,N-dimethyl-benzenesulfonamide, 2-Cyano-3-methoxy-N,N-dimethyl-benzenesulfonamide, 2-Cyano-N-ethyl-6-fluoro-3-methoxy-N-methyl-benzenesulfonamide or 2-Cyano-3-difluoromethoxy-N,N-dimethyl-benzenesulfonamide.

24. The pesticidal mixture according to claim 1, comprising at least one compound I of the formula (I) and spinetoram in a weight ratio from 500:1 to 1:100.

25. A method for controlling phytopathogenic harmful fungi, wherein the fungi, their habitat or the plants to be protected against fungal attack, the soil or seed are treated with an effective amount of the pesticidal mixture of claim 2.

26. A method for protecting plants from phytopathogenic harmful fungi, wherein the fungi, their habitat or the plants to be protected against fungal attack, the soil or seed are treated with an effective amount of the pesticidal mixture of claim 2.

27. A method for controlling insects, arachnids or nematodes comprising contacting the insect, arachnids or nematode or their food supply, habitat, breeding grounds or their locus with an effective amount of the pesticidal mixture of claim 1.

28. A method for protecting plants from attack or infestation by arthropodal pests comprising contacting the plant, or the soil or water in which the plant is growing with an effective amount of the pesticidal mixture of claim 1.

29. The method according to claim 25, wherein the pesticidal mixture is applied in an amount of from 5 g/ha to 2000 g/ha.

30. A method for protection of seed comprising contacting the seeds with an effective amount of a pesticidal mixture of claim 1.

31. The method according to claim 30 wherein the pesticidal mixture is applied in an amount of from 0.001 g to 10 kg per 100 kg of seeds.

32. A method for protecting animals against infestation or infection by parasites which comprises administering to the animals a parasitically effective amount of a pesticidal mixture of claim 1.

33. A method for treating animals infested or infected by parasites which comprises administering to the animals a parasitically effective amount of a pesticidal mixture of claim 1.

34. (canceled)

35. A seed treated with the pesticidal mixture of claim 1 in an amount of from 0.1 g to 10 kg per 100 kg of seed.

36. (canceled)

37. (canceled)

38. (canceled)

39. (canceled)

40. (canceled)
